(19) United States
(12) Patent Application Publication
(10) Pub. No.: US 2010/0080968 A1
(43) Pub. Date: Apr. 1, 2010

(54) Decorative sheet and decorative molded article

(75) Inventors: Katsutoshi Mizuno, Aichi-ken (JP); Tatsuo Ito, Aichi-ken (JP); Takayasu Ido, Aichi-ken (JP); Toshiyuki Hagiyama, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/585,676

(22) Filed: Sep. 22, 2009

(30) Foreign Application Priority Data
Sep. 30, 2008 (JP) 2008-255584
Jun. 30, 2009 (JP) 2009-154599

(51) Int. Cl. B32B 3/10

(52) U.S. Cl. 428/205

(57) ABSTRACT

The present invention provides a decorative sheet which enables to provide a decorative molded article excellent in design property even if the decorative sheet is applied to a decorative molded article requiring deep drawing, and a decorative molded article using the decorative sheet. The decorative sheet is formed by integrally laminating a base material-side adhesion layer, a porous decor sheet, a protective layer-side adhesive layer, and a surface protective layer in this order from a rear surface side. The decorative molded article is obtained by forming a curved portion in the decorative sheet and injection-molding the base material resin at the rear surface side of the decorative sheet.

### CROSS-REFERENCES TO RELATED APPLICATIONS

The present application claims priority under 35 U.S.C. §119 to Japanese Patent Application No. 2008-255584, filed Sep. 30, 2008, entitled “DECORATIVE SHEET AND DECORATIVE MOLDED ARTICLE” and Japanese Patent Application No. 2009-154599, filed Jun. 30, 2009, entitled “DECORATIVE SHEET AND DECORATIVE MOLDED ARTICLE”. The contents of this application are incorporated herein by reference in their entirety.

### BACKGROUND OF THE INVENTION

1. Field of the Invention

The present invention relates to a decorative sheet obtained by forming a curved portion by vacuum molding or hot-press molding, and injection-molding a base material resin to the rear surface side in a mold thereby to be integrated with the base material resin, and a decorative molded article formed by integrating the decorative sheet and the base material resin.

2. Description of the Related Art

In the interior or the like of an automobile such as an armrest, a decorative molded article obtained by in-molding a decorative sheet using a sliced veneer of wood (porous decor sheet) has been used for decoration.

Conventionally, when the decorative molded article is produced, a sliced veneer of wood 92 having a thickness of about 200 to 500 μm is first prepared as a porous decor sheet as shown in FIG. 12A.

Then, as shown in FIG. 12B, the sliced veneer 92 is impregnated with a thermosetting resin 93 such as a polyester styrene cross-linked alkyd resin to obtain a decorative sheet 90. Next, as shown in FIG. 13A, an adhesive layer 94 that is suitable for a base material resin to be molded later is bonded to the rear surface side of the decorative sheet 90. Then, as shown in FIG. 13B, the decorative sheet 90 is inserted in a mold, followed by injection-molding the base material resin to the rear surface side to obtain an intermediate molded article 97.

As shown in FIGS. 7C to 7F, in order to give appearance characteristics excellent in, for example, smoothness, transparency, and depth to the intermediate molded article 97, a first clear layer 95 made of polyester is formed on the surface of the decorative sheet 90 by coating, followed by polishing the coated surface. Further, a second clear layer 96 is applied onto the first clear layer 95, followed by polishing the coated surface to obtain a decorative molded article 98.

However, in the conventional decorative molded article 98, it is necessary to repeatedly perform the surface polishing and coating more than once at the time of production. For that reason, the production efficiency is low, which hinders cost reduction.

In order to improve production efficiency, there has been developed a method for producing a decorative molded article by producing a decorative sheet formed by lamination of a sliced veneer of wood, a transparent film, and a hard-coat-film, and injection-molding a base material resin to a rear surface side of the decorative sheet (refer to JP 9-226082 Unexamined Patent Publication (Kokai)).

Further, there has been proposed a polycarbonate/single-plate laminate formed by laminating and attaching a single plate onto a polycarbonate resin plate or sheet using any of a moisture curing type of hot melt adhesive, a thermoplastic polyester resin adhesive, and a thermoplastic silane modified resin adhesive (JP 9-267459 Unexamined Patent Publication (Kokai)).

There has also been proposed an in-mold coating method including the steps of: placing a porous skin material in a mold and integrally molding a resin base material to the rear surface of the skin material; and forming a gap between the surface of the skin material and the surface of the mold, injecting a thermosetting coating to the gap, then closing the mold and heating under pressure to form a coated film that expands a function of the skin material on the surface of the skin material has been proposed (refer to JP 2003-159724 Unexamined Patent Publication (Kokai)).

In a method for laminating sheets using an adhesive, it is necessary to form a curved portion on a decorative sheet by vacuum molding or hot-press molding in order to improve shape-following property at the time of injection-molding of a base material resin. In recent years, there is a demand for application of the decorative molded article to interior materials of the automobile which needs to form a relatively large curved portion.

However, when, in the case where deep drawing is performed to form the curved portion having a large curvature, a polycarbonate sheet is used as a clear sheet to be formed on the sliced veneer (i.e., the porous decor sheet), molding at high temperatures exceeding 145° C. is required. As a result, bubbles are occurred from the porous decor sheet and bubbles occurred in the adhesion layer are expanded at the time of molding at high temperatures. Further, dimensional change of the decor sheet might furthermore be occurred. As a result, unevenness is occurred on the clear sheet, which leads to impairment of design property of the decorative molded article.

### SUMMARY OF THE INVENTION

The present invention has been accomplished in view of the above-described conventional problems, and an object of the present invention is to provide a decorative sheet which enables to suppress occurrence of bubbles from a porous decor sheet and occurrence of unevenness on the surface, and to produce a decorative molded article with excellent design property, even if the sheet is employed to a decorative molded article requiring deep drawing, and the decorative molded article using the decorative sheet.

According to a first aspect of the present invention, there is provided a decorative sheet used by forming a curved portion by vacuum molding or hot-press molding, and injection-molding a base material resin to the rear surface side in a mold thereby to be integrated with the base material resin,

wherein the decorative sheet is formed by integrally laminating a base material-side adhesion layer, a porous decor sheet, a protective layer-side adhesive layer, and a transparent surface protective layer from the rear surface side in this order,

the protective layer-side adhesive layer is formed by curing a moisture curing type of transparent polyurethane adhesive,

the surface protective layer contains polymethylmethacrylate, a composite resin of polycarbonate and polybutylene terephthalate or a composite resin of polycarbonate and polyethylene terephthalate as a main component, and has a glass transition point of 90 to 130° C., and

the thickness of the surface protective layer is 300 or more.

According to a second aspect of the present, there is provided a decorative molded article obtained by forming a curved portion on a decorative sheet by vacuum molding or press molding, placing the decorative sheet in a mold, and injection-molding a base material resin to a rear surface side of the decorative sheet in the mold, wherein the decorative sheet according to the first aspect of the present invention is employed as the decorative sheet.

The decorative sheet according to the first aspect is used by forming a curved portion by vacuum molding or hot-press molding, and injection-molding the base material resin to the rear surface side in a mold thereby to be integrated with a base material resin.

The decorative sheet is integrally formed by laminating the base material-side adhesion layer, the decor sheet, the protective layer-side adhesive layer, and the surface protective layer from the rear surface side integrated with a base material resin in this order. The protective layer-side adhesive layer is formed of the moisture curing type of polyurethane adhesive. The protective layer-side adhesive layer formed of the polyurethane adhesive is excellent in flexibility.

The surface protective layer contains polymethylmethacrylate, a composite resin of polycarbonate and polybutylene terephthalate or a composite resin of polycarbonate and polyethylene terephthalate as a main component, and has a glass transition point of 90 to 130° C. and the specified thickness. Thus, the surface protective layer can exhibit excellent flexibility. In addition, when the surface protective layer that contains the composite resin as a main component is employed, the surface protective layer can further exhibit excellent scuff resistance.

Thus, the decorative sheet is excellent in flexibility as a whole. Therefore, the decorative sheet can be subjected to vacuum molding and hot-press molding, for example, at a low temperature of 130° C. or less to the decorative sheet. The curved portion with a large curvature (curvature with a small radius) can be formed even at low temperatures.

For that reason, it is possible to prevent occurrence of bubbles from the porous decor sheet and of unevenness on the surface protective layer. It is also possible to suppress dimensional change of the decor sheet at the time of molding to prevent occurrence of unevenness on the decor sheet.

Therefore, when the decorative sheet is used, excellent design property is exhibited even if the curved portion is formed and the base material resin is injection-molded. That is, the decorative molded article with excellent design property can be produced.

As described above, according to the first aspect, there is provided the decorative sheet which enables to suppress occurrence of bubbles from the porous decor sheet and of unevenness on the surface, ant to provide the decorative molded article with excellent design property even if the sheet is employed to the decorative molded article requiring deep drawing.

As for the decorative molded article according to the second aspect, the invention according to the first aspect is employed as the decorative sheet.

In the decorative sheet according to the first aspect, a curved portion with a large curvature can be formed at low temperatures by vacuum molding or hot-press molding as described above. For that reason, occurrence of bubbles from the porous decor sheet is suppressed. Further, it is possible to suppress dimensional change and occurrence of unevenness on the surface of the decorative sheet. Thus, the decorative molded article can exhibit excellent design property.

### BRIEF DESCRIPTION OF THE DRAWINGS

A more complete appreciation of the invention and many of the attendant advantages thereof become readily apparent with reference to the following detailed description, particularly when considered in conjunction with the accompanying drawings, in which:

FIG. 1 is an explanatory view showing the cross-sectional structure of a decorative molded article having a laminate sheet of a hard-coat sheet and a clear sheet as a surface protective layer according to Example 1;

FIG. 2 is an explanatory view showing a step of molding a decorative sheet and forming a curved portion according to Example 1;

FIG. 3 is an explanatory view showing the decorative sheet in which the curved portion is formed according to Example 1;

FIG. 4 is an explanatory view showing a step of integrally forming a base material resin onto the rear surface of the decorative sheet by injection-molding according to Example 1;

FIG. 5 is an explanatory view showing the cross-sectional structure of a decorative sheet having a laminate sheet of a hard-coat sheet and a clear sheet as a surface protective layer according to Example 1;

FIG. 6 is an explanatory diagram showing the structure of a laminating apparatus according to Example 1;

FIG. 7 is an explanatory view showing the cross-sectional structure of a decorative sheet having only a hard-coat sheet as a surface protective layer according to Example 1;

FIG. 8 is an explanatory view showing the cross-sectional structure of a decorative molded article having only a hard-coat sheet as a surface protective layer according to Example 1;

FIG. 9 is an explanatory view showing the cross-sectional structure of a decorative sheet having only a clear sheet as a surface protective layer according to Example 1;

FIG. 10 is an explanatory view showing the cross-sectional structure of a decorative molded article having only a clear sheet as a surface protective layer according to Example 1;

FIG. 11 is an explanatory view showing the cross-sectional structure of a decorative molded article configured such that a hard-coat layer is formed on a surface protective layer formed of clear sheets according to Example 1;

FIGS. 12A and 12B are explanatory views showing a procedure for producing a conventional decorative sheet;

FIGS. 13A to 13F are explanatory views showing a procedure for producing a conventional decorative molded article;

FIG. 14 is an explanatory view showing the cross-sectional structure of a decorative molded article having a laminate sheet of a hard-coat sheet and a clear sheet as a surface protective layer according to Example 2;

FIG. 15 is an explanatory view showing the cross-sectional structure of a decorative sheet having a laminate sheet of a hard-coat sheet and a clear sheet as a surface protective layer according to Example 2;

FIG. 16A is a photograph substitute for drawing that shows a surface state of a sliced veneer according to Example 2, and

FIG. 16B is an explanatory diagram showing a concave-convex state of the surface of the sliced veneer according to Example 2;

FIG. 17 is an explanatory view showing the cross-sectional structure of a laminate configured such that a surface protective layer with a large thickness is laminated to be formed on the sliced veneer according to Example 2;

FIG. 18 is an explanatory view showing the cross-sectional structure of a laminate configured such that the sliced veneer and a clear sheet are laminated while interposing a surface protective layer with a large thickness therebetween according to Example 2;

FIG. 19 is an explanatory view showing the cross-sectional structure of a laminate configured such that a surface protective layer with a small thickness is laminated to be formed on the sliced veneer according to Example 2; and

FIG. 20 is an explanatory view showing the cross-sectional structure of a laminate configured such that the sliced veneer and a clear sheet are laminated while interposing a surface protective layer with a small thickness therebetween according to Example 2.

### DESCRIPTION OF THE PREFERRED EMBODIMENT

Next, preferred embodiments of the present invention will be described.

The protective layer-side adhesive layer preferably has a thickness of 30 to 150 μm.

When the thickness is less than 30 μm, the adhesive strength of the protective layer-side adhesive layer may be insufficient. When the thickness exceeds 150 μm, on the other hand, bubbles occurred in the protective layer-side adhesive layer are difficult to pass through and thus the bubbles may remain in a final product. From the same viewpoint, it is preferable that the thickness of the base material-side adhesive layer is also from 30 to 150 μm. The thicknesses of the protective layer-side adhesive layer and the base material-side adhesive layer are more preferably 50 μm or more, further preferably 80 μm or more.

The protective layer-side adhesive layer is formed by curing a moisture curing type of transparent polyurethane adhesive.

Here, it is preferable that the viscosity of the polyurethane adhesive is from 1000 to 15000 mPa·s.

When the polyurethane adhesive having a viscosity of less than 1000 mPa·s is used, the adhesive property is reduced and peeling may occur at the adhesive interface. When the viscosity exceeds 15000 mPa·s, on the other hand, bubbles from the decor sheet are easily entrained, and further the polyurethane adhesive in itself likely includes bubbles. Thus, bubbles may occur in the protective layer-side adhesive layer, which may result in reduction of design property of the appearance. From the same viewpoint, it is also preferable that the base material-side adhesive layer is formed of a moisture curing type of polyurethane adhesive having a viscosity of 1000 to 15000 mPa·s.

It is preferable that the Young's modulus of the polyurethane adhesive is 10 MPa or less.

In the case where the Young's modulus exceeds 10 MPa, the curved portion may be floated or peeled when a curved portion with a large curvature is formed at the time of molding. From the same viewpoint, it is also preferable that the base material-side adhesive layer is formed of a moisture curing type of polyurethane adhesive having a Young's modulus of 10 MPa or less. From the same viewpoint, it is also preferable that the base material-side adhesive layer is formed of a moisture curing type of polyurethane adhesive having a Young's modulus of 10 MPa or less.

It is preferable that the protective layer-side adhesive layer is formed so as to have a thickness not less than twice the maximum value of the depth of a groove portion on the surface of the porous decor sheet.

The decor sheet has a porous structure. Therefore, if the thickness of the protective layer-side adhesive layer is small when the decor sheet and the protective layer are bonded by the protective layer-side adhesive layer, bubbles may remain between the protective layer-side adhesive layer and the decor sheet in the groove portion. Since the protective layer-side adhesive layer cannot enter the groove portion sufficiently at the time of pressure bonding the sheet and the layer, bubbles may occur.

As described above, when the protective layer-side adhesive layer is formed so as to have a thickness not less than twice the maximum value of the depth of the groove portion, the protective layer-side adhesive layer sufficiently enters the groove portion at the time of bonding. For that reason, occurrence of bubbles is suppressed.

As described hereinafter, the sliced veneer or the like may be employed as the decor sheet. The groove portion is formed by, for example, a wood channel presents on the surface of the sliced veneer (wooden building materials).

The decorative sheet is used for obtaining the decorative molded article formed by injection-molding the base material resin at the rear surface of the decorative sheet to be integrated with the base material resin.

The base material-side adhesion layer in the decorative sheet is bonding to the base material resin on one surface (the rear surface side) and is attached to the decor sheet on the other surface.

It is preferable that the base material-side adhesion layer has a base material bonding layer that bonds with the base material resin, and a base material-side adhesive layer that attaches between the base material bonding layer and the decor sheet.

In this case, the base material resin layer may be bonded to the base material resin at the base material bonding layer side and may be bonded to the decor sheet at the side of the base material-side adhesive layer.

A paper impregnated with a resin excellent in adhesive property to the base material resin, a resin sheet, and a nonwoven fabric, etc. may be employed as the base material bonding layer. Specific examples of the impregnated paper include papers impregnated with an acrylic resin, a polyurethane resin, a phenol resin, a diallyl phthalate resin, and an epoxy resin.

Specific examples of the resin sheet include sheets formed of alloy materials including an ABS resin, a thermoplastic polyurethane resin, a polyester resin, and a polycarbonate resin; a polypropylene resin; a polyethylene terephthalate resin; a polyvinyl chloride resin; and a polymethyl methacrylate resin. The resin sheet may be attached to the base material resin by thermal fusion bonding.

The thickness of the base material bonding layer may be, for example, from 50 to 1000 μm.

It is preferable that the base material bonding layer is formed of a nonwoven fabric.

In this case, adhesive property to the base material resin can be improved by an anchoring effect using characteristics of a porous nonwoven fabric. Examples of the nonwoven fabric include polyester nonwoven fabrics, rayon nonwoven fabrics, and polyolefin nonwoven fabrics.

It is preferable that the base material-side adhesive layer is formed by curing a moisture curing type of transparent polyurethane adhesive.

In this case, not only the protective layer-side adhesive layer but also the base material-side adhesive layer may be formed using the polyurethane adhesive that is excellent in flexibility. Therefore, the flexibility of the decorative sheet as a whole can further be improved.

It is preferable that a filling layer is formed between the protective layer-side adhesive layer and the decor sheet.

In this case, bubbles occurred from the decor sheet at the time of molding are prevented from entering the protective layer-side adhesive layer. Therefore, in this case, design property of the decorative molded article produced by using the decorative sheet can be further improved.

The filling layer can improve the smoothness of the decor sheet and exhibit a function of preventing bubbles which can occur from the porous decor sheet from entering the protective layer-side adhesive layer.

It is preferable that the filling layer is formed by applying a sealing material that contains a polyurethane resin or an acrylic resin as a main component onto the decor sheet and curing the sealing material.

In this case, the filling layer excellent in flexibility can be formed and the flexibility of the decorative sheet can be further improved. When the sliced veneer of wood is used as the decor sheet, the polyurethane resin exhibits excellent adhesive property to the sliced veneer cellulose. Thus, the adhesive property of the filling layer and the decor sheet can be improved.

The thickness of the filling layer is sufficiently small compared to the protective layer-side adhesive layer. For example, the filling layer can be formed so as to have a thickness of 10 μM or less.

Further, pigments and/or dyes may be added to the sealing material. In this case, the filling layer with a desired color can be formed. For example, the color can be given to the design of the wood grain of the decor sheet. Thus, design property of the decorative sheet can further be improved.

Even if dyes are applied onto the decor sheet instead of adding pigments and dyes to the filling layer, the similar effects are obtained.

Porous sheets such as decorated papers, cloths, carbon fibers, or the sliced veneers of wood obtained by slicing wood materials very thinly may be used as the decor sheet.

It is preferable that the decor sheet is formed by attaching a sliced veneer and a nonwoven fabric formed at the rear surface side of the sliced veneer by use of an adhesive.

Many commercially available decor sheets using the sliced veneer are provided as the laminate formed by attaching the sliced veneer and the nonwoven fabric with the adhesive as described above. In this case, the commercially available decor sheets can be directly used.

The sliced veneer is a porous sheet obtained by shaving wood materials very thinly and can exhibit excellent in design property of wood.

It is preferable to employ the sliced veneer in which the channel portion of the sliced veneer is pressurized and filled with the resin that has a hydroxyl group, forms a hydrogen bonding with cellulose, and forms a urethane bonding with the polyurethane adhesive.

In this case, bubbles are further prevented from occurring from the sliced veneer at the time of molding. Therefore, design property can be further improved.

Polyethylene glycol or polypropylene glycol may be employed as the resin to be pressurized into the channel portion of the sliced veneer. Alternatively, polyester resins such as polybutylene terephthalate or polyethylene terephthalate may also be employed.

Next, the surface protective layer is transparent.

The term “transparency” to be used herein includes colored transparency, and translucency as well as perfect transparency. The same applies for the transparency in the hard-coat sheet, the clear sheet, the protective layer-side adhesive layer, and the filling layer. The decoration effect of the decor sheet can be sufficiently exhibited by the transparency. It is preferable to have the transparency to allow the design of the decor sheet to be seen through when the decorative sheet is visually recognized from the side of the surface protective layer.

When the base material-side adhesive layer is formed, the polyurethane adhesive can be used as with the case of the protective layer-side adhesive layer as described above. The base material-side adhesive layer may or may not be transparent.

In order to avoid the phenomena that the backside of the decor sheet can be seen through the surface of the decorative sheet, the base material-side adhesive layer can be the same color with that of the decor sheet (see-through prevention).

It is preferable that the light transmittance of the surface protective layer is 90% or more.

In this case, when the user visually recognizes the decorative sheet or the decorative molded article formed by integrating the above-described decorative sheet or this decorative sheet with the base material resin from the side of the surface protective layer, the user can well visually recognize the decoration of the decor sheet through the surface protective layer. That is, design property of the decorative sheet can be improved. In this regard, the light transmittance is a total light transmittance.

It is preferable that the degree of cloudiness of the surface protective layer is 2% or less.

In this case, the user can well visually recognize the decoration of the decor sheet through the surface protective layer.

Next, the thickness of the surface protective layer is 300 μm or more.

When the thickness is less than 300 μm, the sense of depth caused by the surface protective layer and the decor sheet is impaired. Thus, design property may be impaired. In this case, when the decorative sheet is kept in a hot environment for a long time, unevenness can easily be occurred due to dimensional change of the decor sheet. From a practical viewpoint, the thickness of the surface protective layer is preferably 1000 μm or less, more preferably 600 μm or less.

The glass transition point of the surface protective layer is from 90 to 130° C.

When the glass transition point is less than 90° C., the heat resistance becomes insufficient. Thus, it can be difficult to apply the decorative sheet and the decorative molded article formed of the above-described decorative sheet, to products which are used in a hot environment, for example, interior equipment for automobiles. When the glass transition point exceeds 130° C., on the other hand, it is necessary to mold the decorative sheet at high temperatures at the time of molding. Thus, bubbles may easily occur from the decor sheet.

Subsequently, it is preferable that the surface protective layer includes a transparent clear sheet that contains a composite resin of polycarbonate and polybutylene terephthalate or a composite resin of polycarbonate and polyethylene terephthalate as a main component and a transparent hard-coat sheet that contains polymethylmethacrylate as a main component in this order from the rear surface side.

In this case, both hardness and flexibility in the surface protective layer can be achieved at a high level simultaneously. That is, the surface protective layer has excellent scuff resistance because of the hard-coat sheet that contains polymethylmethacrylate excellent in hardness as a main component, and has excellent flexibility because of the clear sheet that contains the composite material excellent in flexibility as a main component. In this case, the surface protective layer in itself has the hard-coat sheet with high hardness on the outermost surface. Therefore, a step of forming the hard-coat layer on the surface of the decorative sheet after producing the decorative molded article using the decorative sheet is not needed. This is because even when the hard-coat layer is not formed, sufficiently excellent hardness, and excellent scuff resistance can be exhibited.

Preferably, assuming that the thickness of hard-coat sheet is T1 and the thickness of the clear sheet is T2, T1/T2 is 1/7 to 1.

When T1/T2 is less than 1/7, high hardness of the hard-coat sheet is impaired. Thus, the scuff resistance of the surface protective layer may be reduced. When T1/T2 exceeds 1, on the other hand, the heat resistance of the surface protective layer is reduced. Thus, when the surface protective layer is kept in a hot environment for a long time, unevenness may easily occur.

In the clear sheet, it is preferable that the compounding ratio of polycarbonate (PC) and polybutylene terephthalate (PBT) or polyethylene terephthalate (PET) in the clear sheet is PC:PBT (or PET)=52−85:48−15 based on a weight ratio.

When the compounding ratio of PC is below 52, namely, when the compounding ratio of PBT or PET exceeds 48, the glass transition point of the surface protective layer becomes too low, which results in the reduction of heat resistance. On the other hand, when the compounding ratio of PC exceeds 85, namely, when the compounding ratio of PBT or PET is less than 15, the glass transition point of the surface protective layer becomes too high. Thus, it may be necessary to mold the decorative sheet at high temperatures at the time of molding. For that reason, bubbles may easily be occurred from the decor sheet at the time of molding.

It is preferable that the hard-coat sheet contains an acrylic rubber as an accessory component.

In this case, the flexibility of the hard-coat sheet can be further improved.

In the hard-coat sheet, the compounding ratio of the main component and the accessory component may be 75 to 100:25 to 0 based on the weight ratio. When the amount of the accessory constituent is too large, the scuff resistance may be reduced. More preferably, the compounding ratio of the main component and the accessory component may be 80 to 100:20 to 0.

Next, it is preferable that the surface protective layer is formed by attaching a laminate sheet obtained by co-extruding the hard-coat sheet and the clear sheet to the protective layer-side adhesive layer.

In this case, the surface protective layer formed of the laminate sheet of the hard-coat sheet and the clear sheet can easily be formed.

Further, it is preferable that the surface protective layer is formed of a transparent hard-coat sheet that contains polymethylmethacrylate as a main component.

Specifically, the surface protective layer may be formed of only the hard-coat sheet. In this case, both excellent flexibility and hardness in the surface protective layer formed of polymethylmethacrylate can be achieved simultaneously.

It is preferable that the surface protective layer is formed of a transparent clear sheet that contains a composite resin of polycarbonate and polybutylene terephthalate or a composite resin of polycarbonate and polyethylene terephthalate as a main component.

Specifically, the surface protective layer may be formed of only the clear sheet. In this case, the surface protective layer can exhibit excellent flexibility using characteristics of the clear sheet that contains the composite resin with excellent flexibility as a main component. In this case, the surface protective layer does not have the hard-coat sheet or the like with high hardness, and thus the flexibility of the decorative sheet as a whole can be further improved. For that reason, molding at lower temperatures can be achieved, and thus occurrence of bubbles is further suppressed. In the decorative sheet having the surface protective layer formed of only the clear sheet, the hardness of the surface protective layer is not high. In order to compensate this defect, a hard-coat layer made of a resin with high hardness, for example, an acrylic resin may be formed on the surface protective layer after injection-molding and integrally forming with the base material resin.

Subsequently, the decorative molded article is obtained by forming a curved portion on the decorative sheet by vacuum molding or press molding, placing the decorative sheet in a mold, and injection-molding the base material resin to the rear surface side of the decorative sheet.

The molding temperature of the decorative sheet may be from 90 to 130° C. (sheet temperature). In this case, the curved portion with a large curvature can be formed even at low temperatures and the decorative molded article excellent in surface appearance can be obtained. The molding temperature is more preferably 120° C. or less, further preferably 110° C. or less.

The invention according to the first aspect can be employed as the decorative sheet.

It is preferable that a coating material that contains a thermosetting or ultraviolet-curable acrylic resin or a thermosetting or ultraviolet-curable urethane resin as a main component are applied onto the surface protective layer formed of a clear sheet that contains the composite resin of polycarbonate and polybutylene terephthalate or the composite resin of polycarbonate and polyethylene terephthalate as a main component in the decorative molded article obtained after injection-molding and cured.

It is preferable that the decorative molded article is formed by integrally injection-molding the base material resin to the rear surface side of the decorative sheet, injection-molding a coating material that contains a thermosetting or ultraviolet curing acrylic resin or a thermosetting or ultraviolet-curing urethane resin as a main component on the surface protective layer formed of the clear sheet that contains the composite resin of polycarbonate and polybutylene terephthalate or the composite resin of polycarbonate and polyethylene terephthalate as a main component at the surface side of the decorative sheet.

In these cases, the decorative molded article that has the hard-coat layer with high hardness on the outermost surface of the decorative sheet can be obtained. Thus, the scuff resistance of the decorative molded article can be improved.

Specifically, formation of the hard-coat layer is effective for the case where the decorative sheet having the surface protective layer formed of only the clear sheet is used.

### EXAMPLES

### Example 1

Next, Examples of the present invention will be described.

In the present example, a decorative sheet is produced, and the decorative sheet is used to produce a decorative molded article.

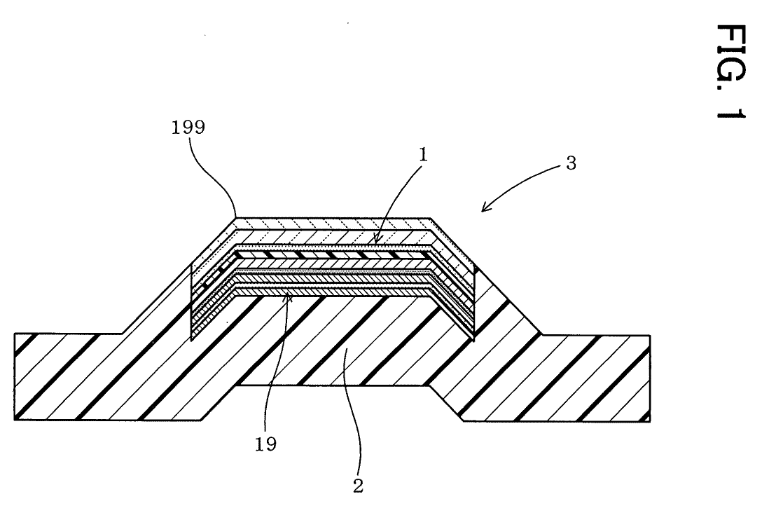

As shown in FIGS. 1 to 4, a decorative sheet 1 of the present example is obtained by forming a curved portion 19 by vacuum molding or hot-press molding, and injection-molding a base material resin 2 to a rear surface side 19 in a mold 5 thereby to be integrated with the base material resin 2.

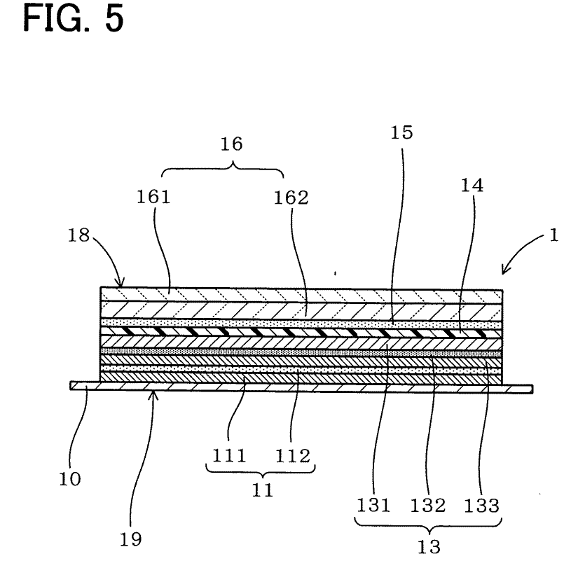

As shown in FIG. 5, the decorative sheet 1 is formed by laminating a base material-side adhesion layer 11, a porous decor sheet 13, a filling layer 14, a protective layer-side adhesive layer 15, and a transparent surface protective layer 16 from the rear surface 19 in which the base material resin is injection-molded in this order. The base material-side adhesion layer 11 is formed of a base material bonding layer 111 and a base material-side adhesive layer 112.

The base material-side adhesive layer 112 is formed by curing the moisture curing type of polyurethane adhesive between the decor sheet 13 and the base material bonding layer 111.

Further, the protective layer-side adhesive layer 15 is formed by curing the transparent moisture curing type of polyurethane adhesive having a viscosity of 5000 mPa·s between the filling layer 14 formed on the decor sheet 13 and the surface protective layer 16.

In the present example, the base material-side adhesive layer 112 and the protective layer-side adhesive layer 15 were produced using the same polyurethane adhesive (a moisture curing type of polyurethane hot melt adhesive).

The surface protective layer 16 is configured such that a laminate sheet, which includes a transparent hard-coat sheet 161 that contains polymethylmethacrylate as a main component, and a transparent clear sheet 162 that contains a composite resin materials of Polycarbonate (PC) and polybutylene terephthalate (PBT), is attached onto the filling layer 14 at the side of the clear sheet 162 while interposing the protective layer-side adhesive layer 15 therebetween (refer to FIG. 5).

The surface protective layer 16 has a glass transition point of 120° C. and a thickness of 400 μm. Assuming that the thickness of the hard-coat sheet 161 is T1 and the thickness of the clear sheet 162 is T2, the thickness ratio of the hard-coat sheet 161 and the clear sheet 162 is T1/T2= 1/7.

Hereinafter, the decorative sheet of the present example will be described in detail.

As shown in FIG. 5, the decorative sheet 1 has the base material bonding layer 111 at the rear surface side 19 where the base material resin is injected. In the present example, the base material bonding layer 111 is formed of a polyester nonwoven fabric. The thickness of the base material bonding layer 111 is about 100 μm. The thickness of the base material bonding layer 111 may be, for example, from 30 to 150 μm.

A laminate sheet obtained by bonding a sliced veneer 131 of wood and a nonwoven fabric 133 with a vinyl acetate adhesive 132 was used as the decor sheet 13. As for the thickness structure of the decor sheet used in the present example, the thickness of the sliced veneer 131 is 300 μm, the thickness of the nonwoven fabric 133 is 0.2 μm, and the thickness of an adhesive layer 132 made of the vinyl acetate adhesive is about 0.1 μm.

For example, a sheet with a thickness of about 0.3 mm to 1 m may be employed as the decor sheet 13.

In addition, the decor sheet 13 and the base material bonding layer 111 are bonded by the base material-side adhesive layer 112 which is formed of the moisture curing type of polyurethane adhesive and has a thickness of 100 μm. The thickness of the base material-side adhesive layer 112 may be 30 to 150 μm.

The filling layer 14 formed of a polyurethane resin is formed on the decor sheet 13 at a surface side 18 opposite to the rear surface side 19 where the base material bonding layer 111 is formed. Formation of the filling layer 14 allows for improving the smoothness of the surface of the decor sheet 13.

The filling layer 14 may be formed by applying a sealing material of the polyurethane resin on the sliced veneer 131 of the decor sheet 13. Some of the sealing materials are easily absorbed into the porous sliced veneer 131. In the present example, the filling layer 14 having a thickness of about 20 μm is formed. The filling layer 14 may be formed so as to have a thickness of about 10 to 30 μm.

The surface protective layer 16 is formed on the filling layer 14 while interposing the protective layer-side adhesive layer 15 therebetween.

The surface protective layer 16 is formed of a laminate sheet of the hard-coat sheet 161 having a thickness of 50 μm and the clear sheet 162 having a thickness of 350 μm and bonded onto the filling layer 14 while interposing the protective layer-side adhesive layer 15 therebetween at the side of the clear sheet 162.

The hard-coat sheet 161 is formed of polymethylmethacrylates (PMMA). The clear sheet 162 is formed of composite resin materials of polycarbonate (PC) and polybutylene terephthalate (PBT). The compounding ratio of PC and PBT (composite resin materials) in the clear sheet 162 is 70:30 based on a weight ratio.

Further, the glass transition point of the surface protective layer 16 formed of the laminate sheet is 120° C.

The glass transition point may be measured with a viscoelasticity measuring apparatus (FT Rheospectler DVE-V4, manufactured by Rheology co., Ltd.).

The total light transmittance of the surface protective layer 16 is 91.2% and the degree of cloudiness (haze) is 1%.

A total light transmittance Lₜ is the light transmittance of a transparent plastic. There is a test for visible light and ultraviolet light. When the haze value is small, the test is carried out using an integrating sphere type light transmittance measuring apparatus. As for the visible light and ultraviolet light, the ratio of an incident light amount L₁ and a total light amount L₂ which has passed through a specimen is expressed in percentage (Lₜ (%)=L₂/L₁×100).

The degree of cloudiness (haze; Lₕ) means the degree of a cloud-like appearance, i.e., unclearness, of the inside of, or on the surface of the transparent plastic. The numerical value is referred to as a cloudiness value (the degree of cloudiness, haze). In the test of the cloudiness value, the light transmittance of the specimen is measured in the same manner as described in the test of the total light transmittance and can be calculated by the equation of Lₕ (%)=L_{d}/Lₜ×100 (L_{d} is a scattered light transmittance and Lₜ is a total light transmittance).

In the present example, Digital haze computer HGM-2DP (manufactured by Suga Test Instruments Co., Ltd.) was used as the integrating sphere type light transmittance measuring apparatus.

The surface protective layer 16 is bonded onto the filling layer 14 via the protective layer-side adhesive layer 15 which is formed of the moisture curing type of polyurethane adhesive and has a thickness of 100 μm. The protective layer-side adhesive layer 15 may be formed so as to have a thickness of about 30 to 150 μm.

Next, the method for producing the decorative sheet of the present example will be described.

First, the decor sheet 13 is prepared. In the present example, a commercially available sheet configured such that the nonwoven fabric 133 was formed at the rear surface of the sliced veneer 131 of wood while interposing the vinyl acetate adhesive 132 therebetween was prepared as the decor sheet 13. In order to improve flexibility, the sliced veneer 131 is pressurized and filled with polyethylene glycol in advance.

Next, the polyester nonwoven fabric having a thickness of about 100 μm was prepared to form the base material bonding layer 111. The moisture curing polyurethane hot melt adhesive having a viscosity of 5000 mPa·s and a Young's modulus of 1 MPa was prepared as the moisture curing type of polyurethane adhesive.

The viscosity of the polyurethane adhesive may be measured using Cone-plate viscometer DV1 (manufactured by Yamato Scientific Co., Ltd.). Further, the Young's modulus can be measured using Strograph VG (manufactured by Toyo Seiki Seisaku-sho, Ltd.).

Then, the base material bonding layer 111 is formed at the rear surface side of the decor sheet 13 while interposing the base material-side adhesive layer 112 formed of the polyurethane adhesive therebetween in the following manner.

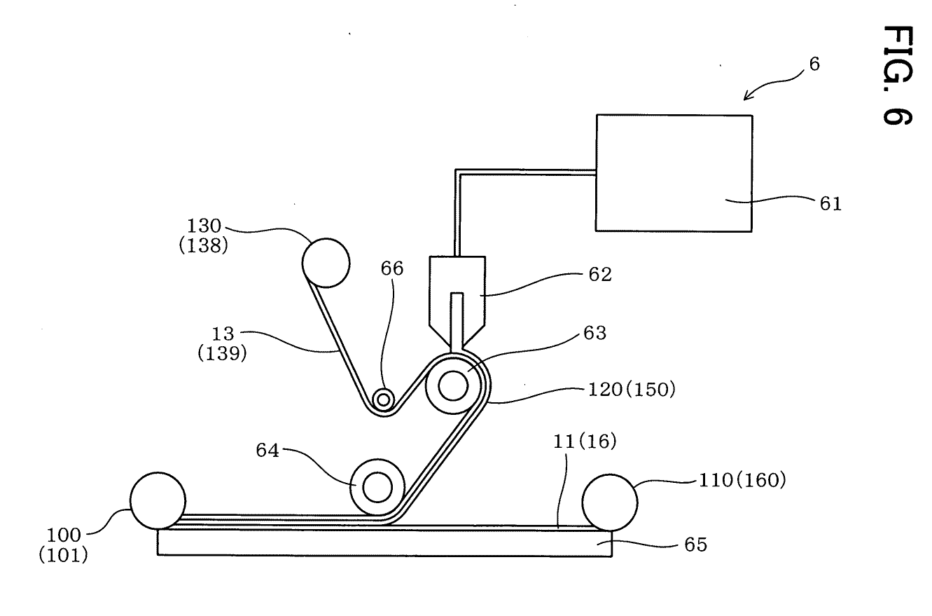

The base material bonding layer is formed using a laminating apparatus 6 as shown in FIG. 6.

The laminating apparatus 6 has a melter 61 which stores the moisture curing type of polyurethane adhesive in a molten state (moisture curing polyurethane hot melt adhesive), a T die 62 which discharges the adhesive, a coating roller 63 which applies an adhesive 120 discharged from the T die 62 onto the decor sheet 13, a pressure bonding roller 64 which pressure-bonds the decor sheet 13 and the polyester nonwoven fabric 111, and a pressure bonding table 65.

A decorative roller 130 formed of the decor sheet 13 and a base material roller 110 formed of a polyester nonwoven fabric 111 are placed in the laminating apparatus 6.

The decor sheet 13 is fed from the decorative roller 130 to the coating roller 63 via a feed roller 66. In the coating roller 63, a moisture curing polyurethane hot melt adhesive 120 in the melter 61 is extruded from the T die 62 and is applied to the rear surface (nonwoven fabric side) of the decor sheet 13 in a predetermined thickness. Further, the decor sheet 13 is fed to the pressure bonding roller 64. On the other hand, the polyester nonwoven fabric 111 is fed from the base material roller 110 to the pressure bonding roller 64 along the pressure bonding table 65. The decor sheet 13 and the polyester nonwoven fabric 111 which have been fed to the pressure bonding roller 64 are pressure-bonded between the pressure bonding roller 64 and the pressure bonding table 65. At this time, the decor sheet 13 and the polyester nonwoven fabric 111 are attached by the adhesive 120 applied to the decor sheet 13. The decor sheet 13 and the polyester nonwoven fabric 111 which are integrally attached are wound by a completed sheet roll 100.

Thus, the base material bonding layer 111 formed of the polyester nonwoven fabric was formed on the rear surface of the decor sheet 13 while interposing the base material-side adhesive layer 112 therebetween (refer to FIG. 5).

Next, a sealing material made of a polyurethane resin was applied onto the surface of the decor sheet 13 opposite to the side of the base material bonding layer 111, namely, the sliced veneer 131 with a roll coater, and then dried. As a result, the filling layer 14 formed of polyurethane resin was formed on the surface of the decor sheet 13.

Then, the surface protective layer 16 is formed on the decor sheet 13 in which the filling layer 14 and the base material bonding layer 111 are formed while interposing the protective layer-side adhesive layer 15 formed of the polyurethane adhesive therebetween in the following manner.

First, the same adhesive used for the base material-side adhesive layer, namely, the moisture curing polyurethane hot melt adhesive having a viscosity of 5000 mPa·s and a Young's modulus of 1 MPa was prepared as the polyurethane adhesive to form the protective layer-side adhesive layer.

Further, a laminate sheet in which the hard-coat sheet 161 made of PMMA (50 μM in thickness) and the clear sheet 162 (350 μm in thickness) were laminated by co-extrusion was prepared as the surface protective layer 16.

In forming the surface protective layer, the laminating apparatus 6 having the same structure of that used for formation of the base material bonding layer was used (refer to FIG. 6).

A decorative roll 138 formed of a decor sheet 139 in which the base material bonding layer and the filling layer were formed and a lamination roll 160 of a laminate sheet 16 formed of the hard-coat sheet and the clear sheet were placed in the laminating apparatus 6.

The decor sheet 139 is fed from the decorative roll 138 to the coating roller 63 via the feed roll 66. In the coating roller 63, a moisture curing polyurethane hot melt adhesive 150 in the melter 61 is extruded from the T die 62 and is applied to the surface (filling layer side) of the decor sheet 139 in a predetermined thickness. Further, the decor sheet 139 is conveyed to the pressure bonding roller 64. On the other hand, the laminate sheet 16 is fed from the lamination roll 160 to the pressure bonding roller 64 along the pressure bonding table 65. The decor sheet 139 and the laminate sheet 16 which have been fed to the pressure bonding roller 64 are pressure-bonded between the pressure bonding roller 64 and the pressure bonding table 65. At this time, the decor sheet 139 and the laminate sheet 16 are attached by an adhesive 150 applied to the decor sheet 139. The decor sheet 139 and the laminate sheet 16 which are integrally bonded are wound by a completed sheet roll 101.

Thus, the surface protective layer 16 formed of a laminate sheet of the hard-coat sheet 161 and the clear sheet 162 was formed on the surface of the decor sheet 13 while interposing the protective layer-side adhesive layer 15 therebetween (refer to FIG. 5).

As shown in FIG. 5, the decorative sheet 1 was produced in the above-described manner. A release sheet 10 can be attached to the rear surface side (base material bonding layer side) of the decorative sheet.

The structure of the decorative sheet produced in the present example is shown in Table 1.

Subsequently, the decorative molded article was produced using the decorative sheet.

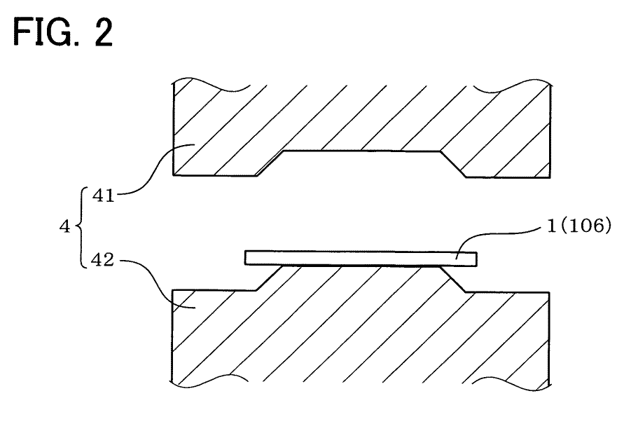

Specifically, as shown in FIG. 2, the decorative sheet 1 was first placed in a mold 4 having an upper mold 41 and a lower mold 42, which was subjected to vacuum molding. The heating temperature at the time of vacuum molding was set to 100° C. (sheet surface temperature).

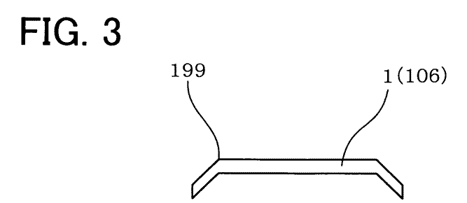

As shown in FIG. 3, a curved portion 199 was formed on the decorative sheet 1 by vacuum molding.

Subsequently, the decorative sheet 1 having the curved portion 199 formed therein was placed in a cavity 55 of the mold 5 for injection-molding having an upper mold 51 and a lower mold 52. Then, the base material resin was injected from a nozzle 201 of an injection-molding machine 200 into the cavity 55 and the base material resin 2 was injection-molded to the rear surface side 19 of the decorative sheet 1. As the base material resin 2, a composite resin (PC/ABS resin) of a PC resin and an ABS resin was used.

Thus, as shown in FIG. 1, a decorative molded article 3 formed by injection-molding the base material resin 2 to the rear surface side 19 of the decorative sheet 1 was produced. The decorative molded article is designated as a sample E1.

Then, the structure of the decorative sheet and molding conditions of the sample E1 were changed to further produce ten types of decorative molded articles (samples E2 to E11).

A sample E2 was produced in the same manner as the sample E1 except that the compounding ratio of PC and PBT in the clear sheet was changed and the glass transition point of the surface protective layer was changed.

Samples E3 and E4 were produced in the same manner as the sample E1 except that the viscosity of the moisture curing polyurethane hot melt adhesive as well as the thicknesses of the base material-side adhesive layer and the protective layer-side adhesive layer made of the adhesive were changed.

A sample E5 was produced in the same manner as the sample E1 except that hot-press molding (heating temperature: 100° C.) was performed instead of vacuum molding.

A sample E6 was produced in the same manner as the sample E1 except that the hard-coat sheet containing PMMA and acrylic rubber at the compounding ratio of PMMA:acrylic rubber=95:5 based on a weight ratio was used.

In a sample E7, the hard-coat sheet containing PMMA and acrylic rubber at the compounding ratio of PMMA:acrylic rubber=80:20 based on a weight ratio was used, and the thickness of the hard-coat sheet was changed. Further, the compounding ratio of PC and PBT in the clear sheet as well as the thickness of the clear sheet were changed, the glass transition point of the surface protective layer was changed, and the molding temperature at the time of vacuum molding was changed. The sample E7 was produced in the same manner as the sample E1 except these conditions.

A sample E8 is the decorative molded article formed using the decorative sheet having only the hard-coat sheet as the surface protective layer instead of the laminate sheet of the hard-coat sheet and the clear sheet in the sample E1.

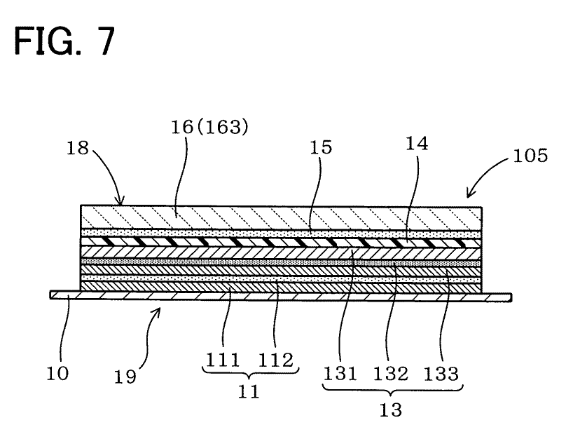

As shown in FIG. 7, a decorative sheet 105 used for the sample E8 is formed by laminating the base material bonding layer 111, the base material-side adhesive layer 112, the porous decor sheet 13, the filling layer 14, the protective layer-side adhesive layer 15, and the surface protective layer 16 from the rear surface side 19 in which the base material resin is integrally injection-molded in this order in the same manner as the case of the sample E1.

In the decorative sheet 105 used for the sample E8, the surface protective layer 16 is formed by attaching a transparent hard-coat sheet 163 that contains polymethylmethacrylate as a main component and has a glass transition point of 90° C. and a thickness of 400 μm onto the filling layer 14 while interposing the protective layer-side adhesive layer 15 therebetween. The decorative molded article can be produced in the same manner as the case of the sample E1 except that the hard-coat sheet 163 is used instead of the laminate sheet.

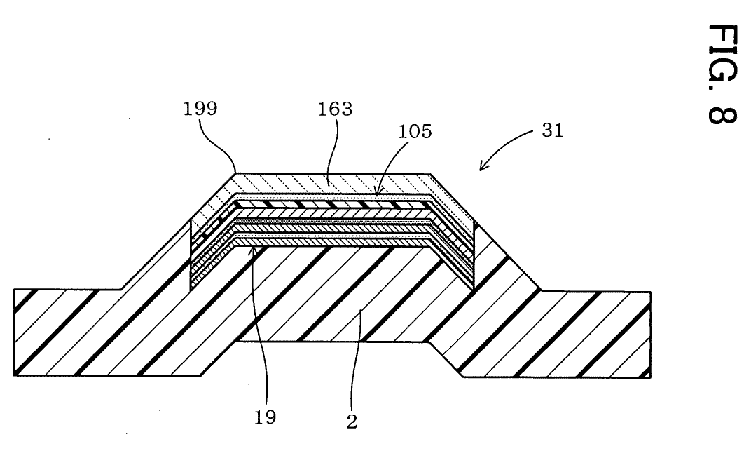

As shown in FIG. 8, a decorative molded article 31 of the sample E8 is formed by forming the curved portion 199 on the decorative sheet 105 having the hard-coat sheet 163 by press-molding, and injection-molding the base material resin 2 at the rear surface side of the decorative sheet 105.

The decorative molded article 31 can be produced in the same manner as the sample E1 except that hot-press molding (temperature: 100° C.) was performed in place of vacuum molding.

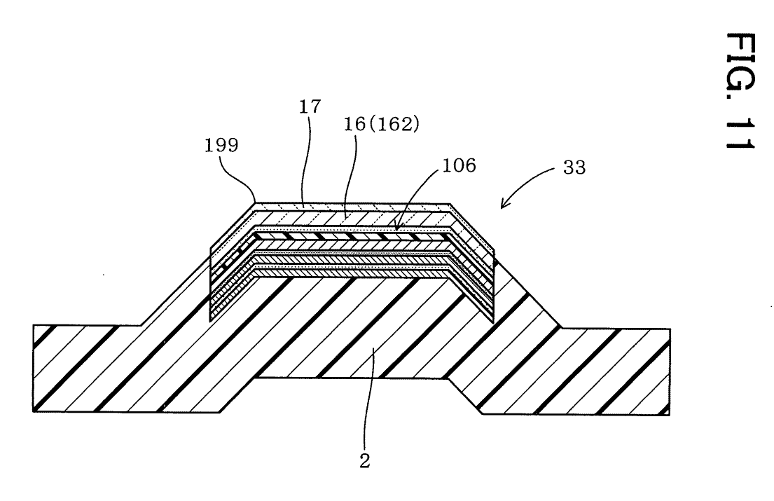

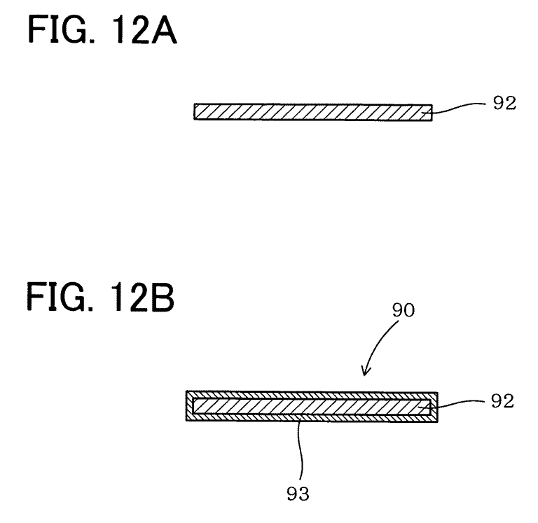

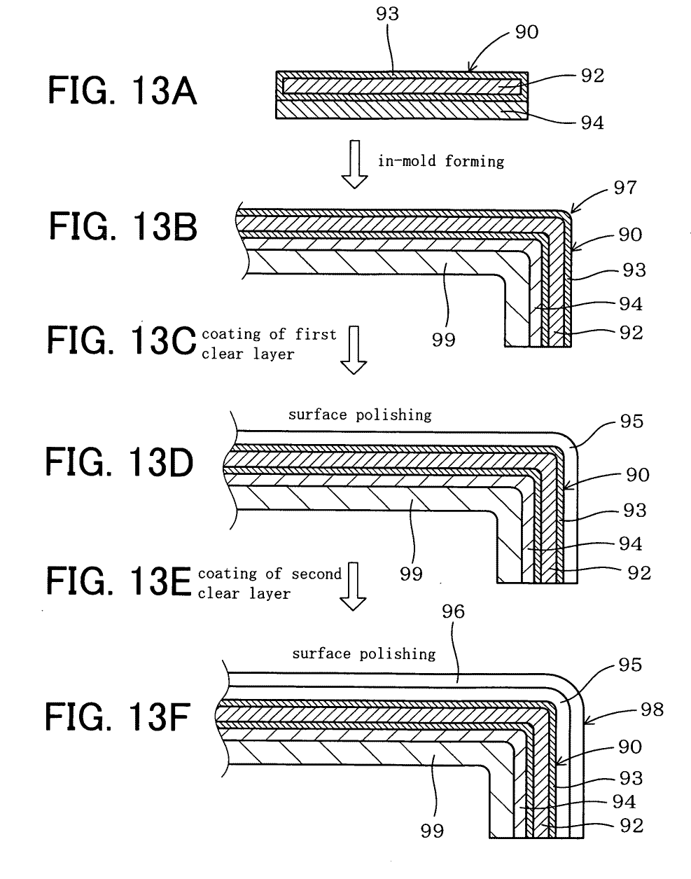

Further, samples E9 and E10 are the decorative molded articles 33 in which a hard-coat layer 17 was formed on the outermost surface (refer to FIG. 11).

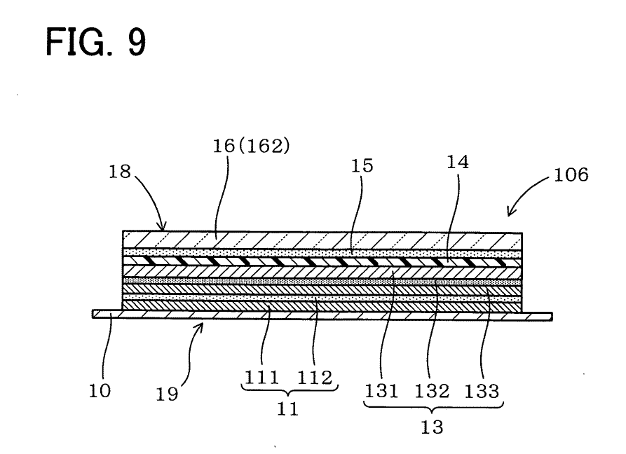

As shown in FIG. 9, a decorative sheet 106 used for the samples E9 and E10 is formed by laminating the base material bonding layer 111, the base material-side adhesive layer 112, the porous decor sheet 13, the filling layer 14, the protective layer-side adhesive layer 15, and the surface protective layer 16 from the rear surface side 19 in which the base material resin is integrally injection-molded in this order starting in the same manner as the case of the sample E1.

In the decorative sheet 106 used for the samples E9 and E10, the surface protective layer 16 is formed by attaching the clear sheet 162 made of a composite resin of a PC and a PBT and has a glass transition point of 120° C. and a thickness of 400 μm onto the filling layer 14 while interposing the protective layer-side adhesive layer 15 therebetween. That is, the decorative sheet 106 used herein has substantially the same structure as that of the sample E1 except that the surface protective layer without having the hard-coat sheet is employed. The decorative sheet 106 can be produced in the same manner as the sample E1 except that only the clear sheet is used instead of the laminate sheet.

The decorative molded article of the sample E9 was produced in the following manner.

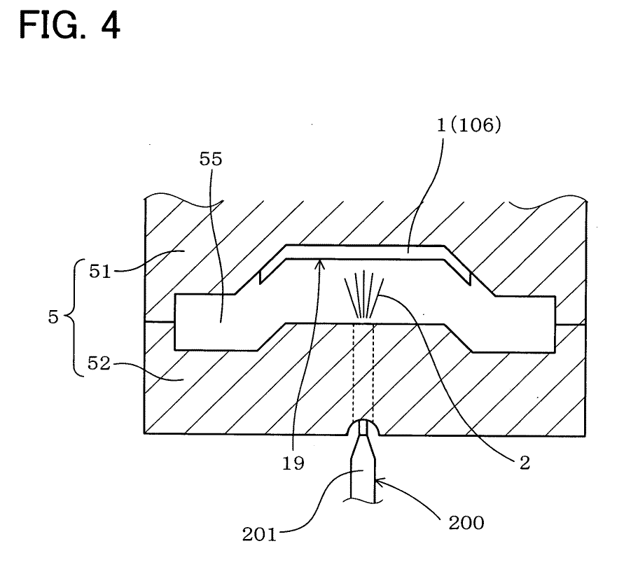

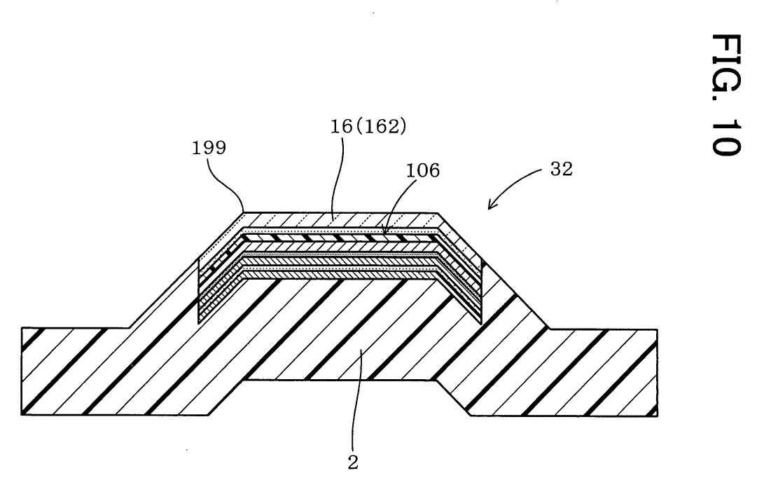

That is, first, the curved portion 199 is formed on the decorative sheet 106 by press-molding in the same manner as the case of the sample E1 (refer to FIGS. 2 and 3). Then, the decorative sheet 106 is placed in the mold 5 and the base material resin 2 is injection-molded to the rear surface side of the decorative sheet 106 (refer to FIG. 4). Thus, a decorative molded article 32 in which the base material resin 2 is integrally formed to the rear surface side of the decorative sheet 106 is obtained (refer to FIG. 10). Here, in the decorative molded article 32 obtained, the outermost surface of the surface protective layer 16 is formed of the clear sheet 162, the scuff resistance is insufficient.

The ultraviolet-curable acrylic resin was applied onto the clear sheet 162, which was cured by UV irradiation to form the transparent hard-coat layer 17 made of PMMA (refer to FIG. 11). As described above, the decorative molded article 33 having the hard-coat layer 17 on the surface was obtained. The decorative molded article 33 is designated as the sample E9.

The sample E10 was produced in the same manner as the sample E9 except that the thermosetting urethane resin was used instead of the ultraviolet-curable resin.

Further, a sample E11 was produced in the same manner as the sample E1 except that the thickness ratio (T1/T2) of the hard-coat sheet and the clear sheet was reduced.

As for the decorative molded articles of the samples E1 to E11 produced as described above, the presence of unevenness on the design surface, floating and peeling, and bubbles were visually judged. Further, the hardness of the outermost surface of the decorative molded articles as well as the adhesive strength of the protective layer-side adhesive layer were measured. Further, the samples E1 to E10 were left under an environment of a temperature of 100° C. for 400 hours, to evaluate the heat resistance. In the heat resistance evaluation, the presence of floating and peeling in the curved portion and unevenness on the surface protective layer were visually judged after 400 hours. The results are shown in Tables 1 and 2.

Further, the structure of the decorative sheet used for each of the samples and molding conditions are shown in Tables 1 and 2. In Tables, the description related to the base material-side adhesive layer of a design sheet is omitted. The omitted description of the structure is the same as that of the sample E1 and no change was made.

In addition, in the present example, six types of decorative molded articles (samples C1 to sample C6) were produced for comparison as comparative examples of the samples E1 to E11.

Samples C1 to C6 can be produced basically in the same manner as the case of the sample E1. Changes between the samples C1 to C6 and the sample E1 are shown in Tables 3 and 4.

As for the samples C1 to C6, the presence of unevenness on the design surface, floating and peeling, and bubbles were visually judged, and hardness of the outermost surface of the decorative molded articles as well as the adhesive strength of the protective layer-side adhesive layer were measured in the same manner as described in the samples E1 to E10. Further, the heat resistance thereof was evaluated. The results are shown in Tables 3 and 4.

TABLE 1

| Sample No. | | | | Sample E1 | Sample E2 | Sample E3 |
|---|---|---|---|---|---|---|
| structure | hard-coat layer | | quality of material | — | — | — |
| | | | film thickness(μ) | — | — | — |
| | surface | hard-coat | quality of material | PMMA | PMMA | PMMA |
| | protective layer | sheet | composition ratio | PMMA: 100 | PMMA: 100 | PMMA: 100 |
| | | | (compounding ratio) | | | |
| | | | board thickness(μ) | 50 | 50 | 50 |
| | | clear | material | PC/PBT | PC/PBT | PC/PBT |
| | | sheet | composition ratio | PC: 70 PBT: 30 | PC: 85 PBT: 15 | PC: 70 PBT: 30 |
| | | | board thickness(μ) | 350 | 350 | 350 |

| | | glass transition point(° C.) | 120 | 130 | 120 |
|---|---|---|---|---|---|
| | | ratio of board thickness of hard-coat | 1/7 | 1/7 | 1/7 |
| | | sheet/clear sheet | | | |
| | | total light transmittance(%) | 91.2 | 91.5 | 91.2 |
| | | haze(%) | 1 | 0.9 | 1 |
| | polyurethane | viscosity (mPa · s) | 5000 | 5000 | 1000 |
| | adhesive of | Young's modulus (Mpa) | 1 | 1 | 1 |
| | protective layer- | film thickness(μ) | 100 | 100 | 30 |
| | side adhesive layer | | | | |
| | filling layer(coating urethane-sealer) | | presence | presence | presence |
| | base material | quality of material | polyester | polyester | polyester |
| | bonding layer | | nonwoven fabrics | nonwoven fabrics | nonwoven fabrics |
| | base material | quality of material | PC/ABS | PC/ABS | PC/ABS |
| molding | vacuum molding temperature | | 100 | 100 | 100 |
| conditions | (sheet surface temperature ° C.) | | | | |
| | hot-press molding (mold temperature ° C.) | | — | — | — |
| quality | appearance | unevenness on the design surface | none | none | none |
| | characteristics | hardness of the outermost surface | 2H | 2H | 2H |
| | | floating and peeling | none | none | none |
| | bubbles | presence of bubbles | none | none | none |
| | adhesion | 80° C. adhesive strength(N/25 mm) | 29.4N | 29.4N | 28.5N |
| | properties | | breaking of | breaking of | breaking of |
| | | | sliced veneer | sliced veneer | sliced veneer |
| | heat | test temperature | 100 | 100 | 100 |
| | resistance | presence of unevenness | none | none | none |
| | | floating and peeling of curved portion | none | none | none |

| Sample No. | | | Sample E4 | Sample E5 |
|---|---|---|---|---|
| structure | hard-coat layer | quality of material | — | — |

| | | | | |
|---|---|---|---|---|
| | | film thickness(μ) | — | — |
| surface | hard-coat | quality of material | PMMA | PMMA |
| protective layer | sheet | composition ratio | PMMA 100 | PMMA: 100 |
| | | (compounding ratio) | | |
| | | board thickness(μ) | 50 | 50 |
| | clear | material | PC/PBT | PC/PBT |
| | sheet | composition ratio | PC: 70 PBT: 30 | PC: 70 PBT: 30 |
| | | board thickness(μ) | 350 | 350 |

| | | glass transition point(° C.) | 120 | 120 |
|---|---|---|---|---|
| | | ratio of board thickness of hard-coat | 1/7 | 1/7 |
| | | sheet/clear sheet | | |
| | | total light transmittance(%) | 91.2 | 91.2 |
| | | haze(%) | 1 | 1 |
| | polyurethane | viscosity (mPa · s) | 15000 | 5000 |
| | adhesive of | Young's modulus (Mpa) | 10 | 1 |
| | protective layer- | film thickness(μ) | 150 | 100 |
| | side adhesive layer | | | |
| | filling layer(coating urethane-sealer) | | presence | presence |
| | base material | quality of material | polyester | polyester |
| | bonding layer | | nonwoven fabrics | nonwoven fabrics |
| | base material | quality of material | PC/ABS | PC/ABS |
| molding | vacuum molding temperature | | 100 | — |
| conditions | (sheet surface temperature ° C.) | | | |
| | hot-press molding (mold temperature ° C.) | | — | 100 |
| quality | appearance | unevenness on the design surface | none | none |
| | characteristics | hardness of the outermost surface | 2H | 2H |
| | | floating and peeling | none | none |
| | bubbles | presence of bubbles | none | none |
| | adhesion | 80° C. adhesive strength(N/25 mm) | 32.3N | 29.4N |
| | properties | | breaking of | breaking of |
| | | | sliced veneer | sliced veneer |
| | heat | test temperature | 100 | 100 |
| | resistance | presence of unevenness | none | none |
| | | floating and peeling of curved portion | none | none |

TABLE 2

| Sample No. | | | | Sample E6 | Sample E7 | Sample E8 |
|---|---|---|---|---|---|---|
| structure | hard-coat layer | | quality of material | — | — | — |
| | | | film thickness(μ) | — | — | — |
| | surface | hard-coat | quality of material | PMMA | PMMA | PMMA |
| | protective layer | sheet | composition ratio | PMMA: 95 | PMMA: 80 | PMMA: 100 |
| | | | (compounding ratio) | acrylic rubber: 5 | acrylic rubber: 20 | |
| | | | board thickness(μ) | 50 | 200 | 400 |
| | | clear | material | PC/PBT | PC/PBT | — |
| | | sheet | composition ratio | PC: 70 PBT: 30 | PC: 52 PBT: 48 | — |
| | | | board thickness(μ) | 350 | 200 | — |
| | | glass transition point(° C.) | | 110 | 102 | 90 |
| | | ratio of board thickness of hard-coat | | 1/7 | 1/1 | — |
| | | sheet/clear sheet | | | | |
| | | total light transmittance(%) | | 90.1 | 90.3 | 95 |
| | | haze(%) | | 0.8 | 0.9 | 0.5 |
| | polyurethane | viscosity (mPa · s) | | 5000 | 5000 | 5000 |
| | adhesive of | Young's modulus (Mpa) | | 1 | 1 | 1 |
| | protective layer- | film thickness(μ) | | 100 | 100 | 100 |
| | side adhesive layer | | | | | |
| | filling layer(coating urethane-sealer) | | | presence | presence | presence |
| | base material | quality of material | | polyester | polyester | polyester |
| | bonding layer | | | nonwoven fabrics | nonwoven fabrics | nonwoven fabrics |
| | base material | quality of material | | PC/ABS | PC/ABS | PC/ABS |
| molding | vacuum molding temperature | | | 100 | 120 | |
| conditions | (sheet surface temperature ° C.) | | | | | |
| | hot-press molding (mold temperature ° C.) | | | — | — | 100 |
| quality | appearance | unevenness on the design surface | | none | none | none |
| | characteristics | hardness of the outermost surface | | 3H | 2H | 2H |
| | | floating and peeling | | none | none | none |
| | bubbles | presence of bubbles | | none | none | none |
| | adhesion | 80° C. adhesive strength(N/25 mm) | | 29.4N | 29.4N | 31.0N |
| | properties | | | breaking of | breaking of | breaking of |
| | | | | sliced veneer | sliced veneer | sliced veneer |
| | heat | test temperature | | 100 | 100 | 100 |
| | resistance | presence of unevenness | | none | none | none |
| | | floating and peeling of curved portion | | none | none | none |
| Sample No. | | | | Sample E9 | Sample E10 | Sample E11 |
| structure | hard-coat layer | | quality of material | PMMA | PU(thermo- | |
| | | | | (UV) | setting- | |
| | | | | | curing) | |
| | | | film thickness(μ) | 20 | 20 | |
| | surface | hard-coat | quality of material | — | — | PMMA |
| | protective layer | sheet | composition ratio | — | — | PMMA: 100 |
| | | | (compounding ratio) | | | |
| | | | board thickness(μ) | — | — | 40 |
| | | clear | material | PC/PBT | PC/PBT | PC/PBT |
| | | sheet | composition ratio | PC: 70 PBT: 30 | PC: 70 PBT: 30 | PC: 70 PBT: 30 |
| | | | board thickness(μ) | 400 | 400 | 360 |

| | | glass transition point(° C.) | 120 | 120 | 100 |
|---|---|---|---|---|---|
| | | ratio of board thickness of hard-coat | 1/7 | 1/7 | 1/9 |
| | | sheet/clear sheet | | | |
| | | total light transmittance(%) | 91.2 | 91.2 | 92 |
| | | haze(%) | 1 | 1 | 0.2 |
| | polyurethane | viscosity (mPa · s) | 5000 | 5000 | 5000 |
| | adhesive of | Young's modulus (Mpa) | 1 | 1 | 1 |
| | protective layer- | film thickness(μ) | 100 | 100 | 100 |
| | side adhesive layer | | | | |
| | filling layer(coating urethane-sealer) | | presence | presence | presence |
| | base material | quality of material | polyester | polyester | polyester |
| | bonding layer | | nonwoven fabrics | nonwoven fabrics | nonwoven fabrics |
| | base material | quality of material | PC/ABS | PC/ABS | PC/ABS |
| molding | vacuum molding temperature | | 100 | 100 | 100 |
| conditions | (sheet surface temperature ° C.) | | | | |
| | hot-press molding (mold temperature ° C.) | | — | — | — |
| quality | appearance | unevenness on the design surface | none | none | none |
| | characteristics | hardness of the outermost surface | 2H | 2H | HB |
| | | floating and peeling | none | none | none |
| | bubbles | presence of bubbles | none | none | none |
| | adhesion | 80° C. adhesive strength(N/25 mm) | 29.4N | 29.4N | 29.4N |
| | properties | | breaking of | breaking of | breaking of |
| | | | sliced veneer | sliced veneer | sliced veneer |
| | heat | test temperature | 100 | 100 | 100 |
| | resistance | presence of unevenness | none | none | none |
| | | floating and peeling of curved portion | none | none | none |

TABLE 3

| Sample No. | | | | Sample C1 | Sample C2 | Sample C3 | Sample C4 |
|---|---|---|---|---|---|---|---|
| structure | hard-coat layer | | quality of material | | | — | |
| | | | film thickness(μ) | | | — | |
| | surface | hard-coat | quality of material | PMMA | PMMA | PMMA | PMMA |
| | protective layer | sheet | composition ratio | PMMA: 100 | PMMA: 100 | PMMA: 100 | PMMA: 100 |
| | | | (compounding ratio) | | | | |
| | | | board thickness(μ) | 50 | 50 | 50 | 50 |
| | | clear | material | PC | PC/PBT | PC/PBT | PC/PBT |
| | | sheet | composition ratio | PC: 100% | PC: 48 PBT: 52 | PC: 70 PBT: 30 | PC: 70 PBT: 30 |
| | | | board thickness(μ) | 350 | 350 | 350 | 350 |

| | | glass transition point(° C.) | 132 | 82 | 120 | 100 |
|---|---|---|---|---|---|---|
| | | ratio of board thickness of hard-coat | 1/7 | 1/7 | 1/7 | 1/7 |
| | | sheet/clear sheet | | | | |
| | | total light transmittance(%) | 90 | 82 | 91.2 | 91.2 |
| | | haze(%) | 1 | 4.5 | 1 | 1 |
| | polyurethane | viscosity (mPa · s) | 5000 | 5000 | 500 | 20000 |
| | adhesive of | Young's modulus (Mpa) | 1 | 1 | 1 | 15 |
| | protective layer- | film thickness(μ) | 0.1 | 100 | 50 | 150 |
| | side adhesive layer | | | | | |
| | filling layer(coating urethane-sealer) | | none | none | presence | presence |
| | base material | quality of material | polyester | polyester | polyester | polyester |
| | bonding layer | | nonwoven fabrics | nonwoven fabrics | nonwoven fabrics | nonwoven fabrics |
| | base material | quality of material | PC/ABS | PC/ABS | PC/ABS | PC/ABS |
| molding | vacuum molding temperature | | 148 | 85 | 100 | 100 |
| conditions | (sheet surface temperature ° C.) | | | | | |
| | hot-press molding (mold temperature ° C.) | | — | — | — | — |
| quality | appearance | unevenness on the design surface | presence | presence | none | none |
| | characteristics | hardness of the outermost surface | 2H | 2H | 2H | 2H |
| | | floating and peeling | presence | none | none | none |
| | bubbles | presence of bubbles | presence | none | none | presence |
| | adhesion | 80° C. adhesive strength(N/25 mm) | 29.8N | 30.5N | 15.3N | 38.5N |
| | properties | | breaking of | breaking of | peeling of | breaking of |
| | | | sliced veneer | sliced veneer | interface | sliced veneer |
| | heat | test temperature | 100 | 100 | 100 | 100 |
| | resistance | presence of unevenness | none | presence | none | none |
| | | floating and peeling of curved portion | none | none | none | presence |

TABLE 4

| Sample No. | | | | Sample C5 | Sample C6 |
|---|---|---|---|---|---|
| structure | hard-coat layer | | quality of material | | — |
| | | | film thickness(μ) | | — |
| | surface | hard-coat | quality of material | PMMA | PMMA |
| | protective layer | sheet | composition ratio | PMMA: 100 | PMMA: 70 |
| | | | (compounding ratio) | | acrylic rubber: 30 |
| | | | board thickness(μ) | 300 | 50 |
| | | clear | material | PC/PBT | PC/PBT |
| | | sheet | composition ratio | PC: 70 PBT: 30 | PC: 52 PBT: 48 |
| | | | board thickness(μ) | 100 | 350 |

| glass transition point(° C.) | 87 | 86 |
|---|---|---|
| ratio of board thickness of hard-coat | 3/1 | 1/7 |
| sheet/clear sheet | | |
| total light transmittance(%) | 93 | 90.3 |
| haze(%) | 0.3 | 0.9 |

| | polyurethane | viscosity (mPa · s) | 5000 | 5000 |
|---|---|---|---|---|
| | adhesive of | Young's modulus (Mpa) | 1 | 1 |
| | protective layer- | film thickness(μ) | 100 | 100 |
| | side adhesive layer | | | |
| | filling layer(coating urethane-sealer) | | presence | presence |
| | base material | quality of material | polyester | polyester |
| | bonding layer | | nonwoven fabrics | nonwoven fabrics |
| | base material | quality of material | PC/ABS | PC/ABS |
| molding | vacuum molding temperature | | 85 | 120 |
| conditons | (sheet surface temperature ° C.) | | | |
| | hot-press molding (mold temperature ° C.) | | — | — |
| quality | appearance | unevenness on the design surface | presence | none |
| | characteristics | hardness of the outermost surface | 2H | HB |
| | | floating and peeling | none | presence |
| | bubbles | presence of bubbles | none | none |
| | adhesion | 80° C. adhesive strength(N/25 mm) | 29.4N | 29.4N |
| | properties | | breaking of | breaking of |
| | | | sliced veneer | sliced veneer |
| | heat | test temperature | 100 | 100 |
| | resistance | presence of unevenness | presence | none |
| | | floating and peeling of curved | none | none |

As is apparent from Tables 3 and 4, in the samples C1, C2, C5, and C6 in which the surface protective layer with a glass transition point out of the range of 90 to 130° C. was formed, unevenness was occurred on the design surface, and the presence of floating and peeling was observed. Further, occurrence of bubbles was observed. They have poor design property and the commercial value is low.

Further, the adhesive strength of sample C3 in which the protective layer-side adhesive layer was formed using the polyurethane adhesive having a very low viscosity might become insufficient. On the other hand, in sample C4 in which the protective layer-side adhesive layer was formed using the polyurethane adhesive having a very high viscosity, the presence of floating and peeling was observed in the heat resistance test. Further, occurrence of bubbles was observed.

On the other hand, the samples E1 and E11 according to Examples of the present invention were excellent in appearance characteristics and exhibited excellent design property. Further, they were also excellent in adhesive property and heat resistance.

However, although occurrence of bubbles was suppressed and appearance characteristics were excellent in the sample E11 in which the thickness ratio (T1/T2) of the hard-coat sheet and the clear sheet was reduced, the surface hardness was insufficient, and the scuff resistance was deteriorated.

Thus, according to the present example, there can be provided the decorative sheet which enables to suppress occurrence of bubbles from the porous decor sheet and occurrence of unevenness on the surface, and to produce the decorative molded article with excellent design property, even if the sheet is applied to the decorative molded article requiring deep drawing, and the decorative molded articles (the samples E1 to E11).

### Example 2

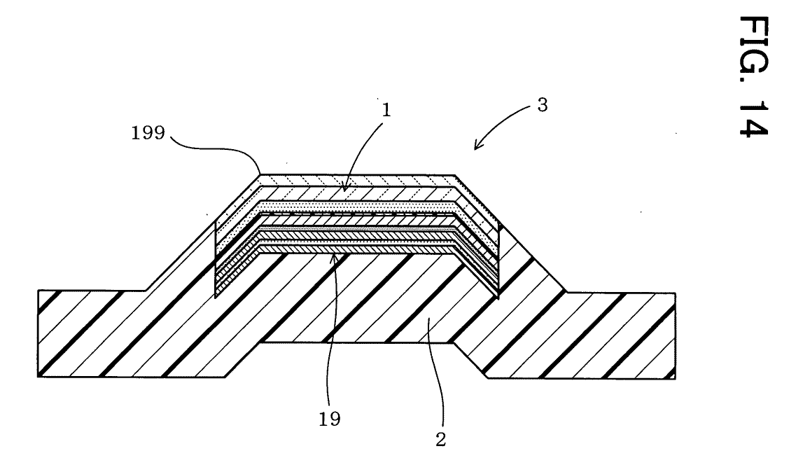

In present example, as shown in FIG. 14, a decorative molded article 3 is produced by forming the curved portion 19 on the decorative sheet 1, and injection-molding the base material resin to the rear surface side 19 of the decorative sheet 1 in the same manner as described in Example 1.

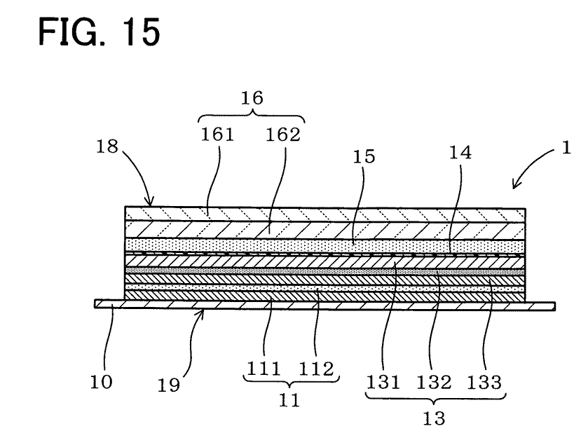

As shown in FIG. 15, the decorative sheet of the present example is formed by laminating the base material-side adhesion layer 11, the porous decor sheet 13, the filling layer 14, the protective layer-side adhesive layer 15, and the transparent surface protective layer 16 from the rear surface side 19 in which the base material resin is integrally injection-molded in this order in the same manner described in Example 1. The base material-side adhesion layer 11 can be formed of the base material bonding layer 111 and the base material-side adhesive layer 112. The surface protective layer 16 can be formed of the hard-coat sheet 161 and the clear sheet 162. Further, the decor sheet 13 can be formed of the sliced veneer 131, the adhesive layer 132, and the nonwoven fabric 133.

In the present example, the structure of the decorative sheet and molding conditions or the like were changed to produce 17 types of decorative molded articles (samples E12 to E22 and samples C7 to C12) in the same manner as described in Example 1. The structure of the decorative sheet used for each of the samples and molding conditions are shown in Tables 5 to 8. Further, the material of the decor sheet (sliced veneer), the groove (channel) depth, and the ratio of the thickness of the protective layer-side adhesive layer and the groove (channel) depth (thickness/channel depth of adhesive layer at the protective layer side) are shown in Tables 5 to 8.

The groove depth of the decor sheet was defined as the maximum value of the channel depth in the cross section of the sliced veneer. The depth of the groove portion was measured using Digital microscope VHX-900 (manufactured by KEYENCE).

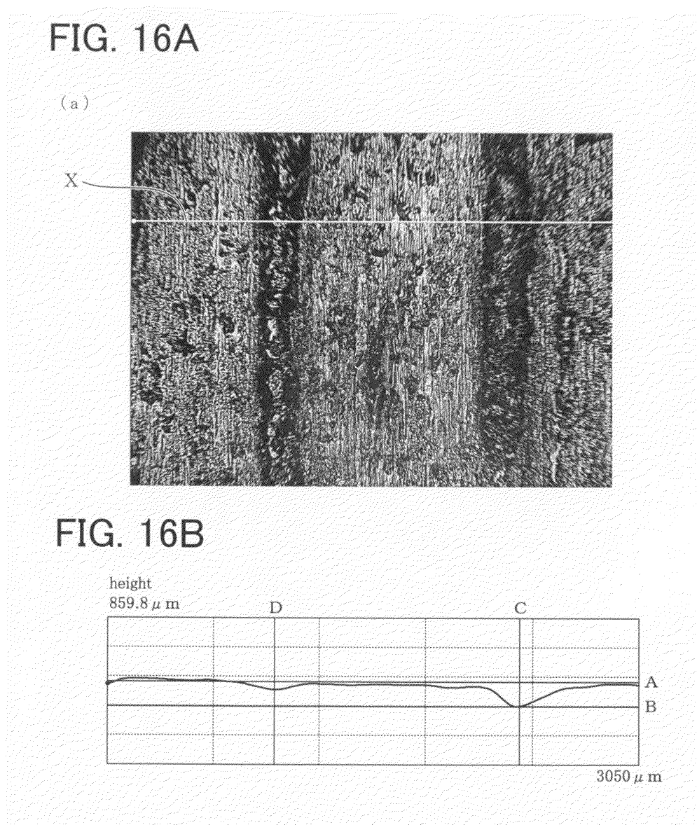

As an example of the decor sheet (sliced veneer), a micrograph (magnification; 100 times) of the groove portion (channel) on the surface of bubinga is shown in FIG. 16A. The depth of the groove portion on a line X shown in FIG. 16A is shown in FIG. 16B. The depth of the groove portion as to the whole surface of the decor sheet was measured. The maximum value of the depth, namely, the maximum value of the height between A-B in FIG. 16B was defined as the groove depth of the decor sheet (the channel depth of the sliced veneer).

As for each sample (the samples E12 to E22 and the samples C7 and C12), the presence of unevenness on the design surface, floating and peeling, and bubbles were visually judged in the same manner as described in Example 1. Further, the hardness of the outermost surface of the decorative molded articles as well as the adhesive strength of the protective layer-side adhesive layer were measured. Further, each sample was left under an environment of a temperature of 100° C. for 400 hours to evaluate the heat resistance. In the heat resistance evaluation, the presence of floating and peeling in the curved portion and the presence of unevenness on the surface protective layer were visually judged after 400 hours. The results are shown in Tables 9 to 12. Further, the radius of curvature of the curved portion is shown in Tables 9 to 12. As for the radius of curvature, the curvature of the outermost surface of each sample (the surface of the clear sheet when it had the clear sheet) was measured using an R gauge.

TABLE 5

| Sample No. | | | | Sample E12 | Sample E13 | Sample E14 |
|---|---|---|---|---|---|---|
| structure | hard-coat layer | | quality of material | — | — | — |
| | | | film thickness(μ) | — | — | — |
| | surface | hard-coat | quality of material | PMMA | PMMA | PMMA |
| | protective layer | sheet | composition ratio | PMMA: 100 | PMMA: 100 | PMMA: 100 |
| | | | (compounding ratio) | | | |
| | | | board thickness(μ) | 50 | 50 | 50 |
| | | clear | material | PC/PBT | PC/PBT | PC/PBT |
| | | sheet | composition ratio | PC: 70 PBT: 30 | PC: 85 PBT: 15 | PC: 70 PBT: 30 |
| | | | board thickness(μ) | 350 | 350 | 350 |

| | glass transition point(° C.) | 120 | 130 | 120 |
|---|---|---|---|---|
| | ratio of board thickness of hard-coat | 1/7 | 1/7 | 1/7 |
| | sheet/clear sheet | | | |
| | total light transmittance(%) | 91.2 | 91.5 | 91.2 |
| | haze(%) | 1 | 0.9 | 1 |
| polyurethane | viscosity (mPa · s) | 5000 | 5000 | 1000 |
| adhesive of | Young's modulus (Mpa) | 1 | 1 | 1 |
| protective layer- | film thickness(μ) | 120 | 120 | 240 |
| side adhesive layer | | | | |
| filling layer(coating urethane-sealer) | | presence | presence | presence |
| decor sheet | kind of material | Birds Eye | Birds Eye | Bubinga |
| (sliced veneer) | channel depth(μ) | 60 | 60 | 120 |
| (thickness/channel depth of adhesive | | 2/1 | 2/1 | 2/1 |
| layer at the protective layer side) | | | | |
| base material | quality of material | polyester | polyester | polyester |
| bonding layer | | nonwoven fabrics | nonwoven fabrics | nonwoven fabrics |
| base material | quality of material | PC/ABS | PC/ABS | PC/ABS |

| | | | | |
|---|---|---|---|---|
| molding | vacuum molding temperature | 100 | 100 | 100 |
| conditions | (sheet surface temperature ° C.) | | | |
| | hot-press molding (mold temperature ° C.) | — | — | — |

| Sample No. | | | Sample E15 | Sample E16 |
|---|---|---|---|---|
| structure | hard-coat layer | quality of material | — | — |

| | | | | |
|---|---|---|---|---|
| | | film thickness(μ) | — | — |
| surface | hard-coat | quality of material | PMMA | PMMA |
| protective layer | sheet | composition ratio | PMMA 100 | PMMA: 100 |
| | | (compounding ratio) | | |
| | | board thickness(μ) | 50 | 50 |
| | clear | material | PC/PBT | PC/PBT |
| | sheet | composition ratio | PC: 70 PBT: 30 | PC: 70 PBT: 30 |
| | | board thickness(μ) | 350 | 350 |

| | glass transition point(° C.) | 120 | 120 |
|---|---|---|---|
| | ratio of board thickness of hard-coat | 1/7 | 1/7 |
| | sheet/clear sheet | | |
| | total light transmittance(%) | 91.2 | 91.2 |
| | haze(%) | 1 | 1 |
| polyurethane | viscosity (mPa · s) | 15000 | 5000 |
| adhesive of | Young's modulus (Mpa) | 10 | 1 |
| protective layer- | film thickness(μ) | 240 | 120 |
| side adhesive layer | | | |
| filling layer(coating urethane-sealer) | | presence | presence |
| decor sheet | kind of material | Bubinga | Birds Eye |
| (sliced veneer) | channel depth(μ) | 120 | 60 |
| (thickness/channel depth of adhesive | | 2/1 | 2/1 |
| layer at the protective layer side) | | | |
| base material | quality of material | polyester | polyester |
| bonding layer | | nonwoven fabrics | nonwoven fabrics |
| base material | quality of material | PC/ABS | PC/ABS |

| | | | |
|---|---|---|---|
| molding | vacuum molding temperature | 100 | — |
| conditions | (sheet surface temperature ° C.) | | |
| | hot-press molding (mold temperature ° C.) | — | 100 |

TABLE 6

| Sample No. | | | | Sample E17 | Sample E18 | Sample E19 |
|---|---|---|---|---|---|---|
| structure | hard-coat layer | | quality of material | — | — | — |
| | | | film thickness(μ) | — | — | — |
| | surface | hard-coat | quality of material | PMMA | PMMA | PMMA |
| | protective layer | sheet | composition ratio | PMMA: 95 | PMMA: 80 | PMMA: 100 |
| | | | (compounding ratio) | acrylic rubber: 5 | acrylic rubber: 20 | |
| | | | board thickness(μ) | 50 | 200 | 400 |
| | | clear | material | PC/PBT | PC/PBT | — |
| | | sheet | composition ratio | PC: 70 PBT: 30 | PC: 52 PBT: 48 | — |
| | | | board thickness(μ) | 350 | 200 | — |
| | | glass transition point(° C.) | | 110 | 102 | 90 |
| | | ratio of board thickness of hard-coat | | 1/7 | 1/1 | — |
| | | sheet/clear sheet | | | | |
| | | total light transmittance(%) | | 90.1 | 90.3 | 95 |
| | | haze(%) | | 0.8 | 0.9 | 0.5 |
| | polyurethane | viscosity (mPa · s) | | 5000 | 5000 | 5000 |
| | adhesive of | Young's modulus (Mpa) | | 1 | 1 | 1 |
| | protective layer- | film thickness(μ) | | 120 | 120 | 120 |
| | side adhesive layer | | | | | |
| | filling layer(coating urethane-sealer) | | | presence | presence | presence |
| | decor sheet | kind of material | | Birds Eye | Birds Eye | Birds Eye |
| | (sliced veneer) | channel depth(μ) | | 60 | 60 | 60 |
| | (thickness/channel depth of adhesive | | | 2/1 | 2/1 | 2/1 |
| | layer at the protective layer side) | | | | | |
| | base material | quality of material | | polyester | polyester | polyester |
| | bonding layer | | | nonwoven fabrics | nonwoven fabrics | nonwoven fabrics |
| | base material | quality of material | | PC/ABS | PC/ABS | PC/ABS |
| molding | vacuum molding temperature | | | 100 | 120 | |
| conditions | (sheet surface temperature ° C.) | | | | | |
| | hot-press molding (mold temperature ° C.) | | | — | — | 100 |
| Sample No. | | | | Sample E20 | Sample E21 | Sample E22 |
| structure | hard-coat layer | | quality of material | PMMA (UV) | PU(thermo- | — |
| | | | | | setting- | |
| | | | | | curing) | |
| | | | film thickness(μ) | 20 | 20 | — |
| | surface | hard-coat | quality of material | — | — | PMMA |
| | protective layer | sheet | composition ratio | — | — | PMMA: 100 |
| | | | (compounding ratio) | | | |
| | | | board thickness(μ) | — | — | 40 |
| | | clear | material | PC/PBT | PC/PBT | PC/PBT |
| | | sheet | composition ratio | PC: 70 PBT: 30 | PC: 70 PBT: 30 | PC: 70 PBT: 30 |
| | | | board thickness(μ) | 400 | 400 | 360 |

| | glass transition point(° C.) | 120 | 120 | 100 |
|---|---|---|---|---|
| | ratio of board thickness of hard-coat | 1/7 | 1/7 | 1/9 |
| | sheet/clear sheet | | | |
| | total light transmittance(%) | 91.2 | 91.2 | 92 |
| | haze(%) | 1 | 1 | 0.2 |
| polyurethane | viscosity (mPa · s) | 5000 | 5000 | 5000 |
| adhesive of | Young's modulus (Mpa) | 1 | 1 | 1 |
| protective layer- | film thickness(μ) | 120 | 120 | 120 |
| side adhesive layer | | | | |
| filling layer(coating urethane-sealer) | | presence | presence | presence |
| decor sheet | kind of material | Birds Eye | Birds Eye | Birds Eye |
| (sliced veneer) | channel depth(μ) | 60 | 60 | 60 |
| (thickness/channel depth of adhesive | | 2/1 | 2/1 | 2/1 |
| layer at the protective layer side) | | | | |
| base material | quality of material | polyester | polyester | polyester |
| bonding layer | | nonwoven fabrics | nonwoven fabrics | nonwoven fabrics |
| base material | quality of material | PC/ABS | PC/ABS | PC/ABS |

| | | | | |
|---|---|---|---|---|
| molding | vacuum molding temperature | 100 | 100 | 100 |
| conditions | (sheet surface temperature ° C.) | | | |
| | hot-press molding (mold temperature ° C.) | — | — | — |

TABLE 7

| Sample No. | | | | Sample C7 | Sample C8 | Sample C9 | Sample C10 |
|---|---|---|---|---|---|---|---|
| structure | hard-coat layer | | quality of material | — | — | — | — |
| | | | film thickness(μ) | — | — | — | — |
| | surface | hard-coat | quality of material | PMMA | PMMA | PMMA | PMMA |
| | protective layer | sheet | composition ratio | PMMA: 100 | PMMA: 100 | PMMA: 100 | PMMA: 100 |
| | | | (compounding ratio) | | | | |
| | | | board thickness(μ) | 50 | 50 | 50 | 50 |
| | | clear | material | PC | PC/PBT | PC/PBT | PC/PBT |
| | | sheet | composition ratio | PC: 100% | PC: 48 PBT: 52 | PC: 70 PBT: 30 | PC: 70 PBT: 30 |
| | | | board thickness(μ) | 350 | 350 | 350 | 350 |

| | glass transition point(° C.) | 132 | 82 | 120 | 100 |
|---|---|---|---|---|---|
| | ratio of board thickness of hard-coat | 1/7 | 1/7 | 1/7 | 1/7 |
| | sheet/clear sheet | | | | |
| | total light transmittance(%) | 90 | 82 | 91.2 | 91.2 |
| | haze(%) | 1 | 4.5 | 1 | 1 |
| polyurethane | viscosity (mPa · s) | 5000 | 5000 | 500 | 20000 |
| adhesive of | Young's modulus (Mpa) | 1 | 1 | 1 | 15 |
| protective layer- | film thickness(μ) | 120 | 120 | 50 | 200 |
| side adhesive layer | | | | | |
| filling layer(coating urethane-sealer) | | none | none | presence | presence |
| decor sheet | kind of material | Birds Eye | Birds Eye | Birds Eye | Bubinga |
| (sliced veneer) | channel depth(μ) | 60 | 60 | 60 | 120 |
| (thickness/channel depth of adhesive | | 2/1 | 2/1 | 5/6 | 4/3 |
| layer at the protective layer side) | | | | | |
| base material | quality of material | polyester | polyester | polyester | polyester |
| bonding layer | | nonwoven fabrics | nonwoven fabrics | nonwoven fabrics | nonwoven fabrics |
| base material | quality of material | PC/ABS | PC/ABS | PC/ABS | PC/ABS |

| | | | | | |
|---|---|---|---|---|---|
| molding | vacuum molding temperature | 148 | 85 | 100 | 100 |
| conditions | (sheet surface temperature ° C.) | | | | |
| | hot-press molding (mold temperature ° C.) | — | — | — | — |

TABLE 8

| Sample No. | | | | Sample C11 | Sample C12 |
|---|---|---|---|---|---|
| structure | hard-coat layer | | quality of material | — | — |
| | | | film thickness(μ) | — | — |
| | surface | hard-coat | quality of material | PMMA | PMMA |
| | protective layer | sheet | composition ratio | PMMA: 100 | PMMA: 70 |
| | | | (compounding ratio) | | acrylic rubber: 30 |
| | | | board thickness(μ) | 300 | 50 |
| | | clear | material | PC/PBT | PC/PBT |
| | | sheet | composition ratio | PC: 70 PBT: 30 | PC: 52 PBT: 48 |
| | | | board thickness(μ) | 100 | 350 |

| | glass transition point(° C.) | 87 | 86 |
|---|---|---|---|
| | ratio of board thickness of hard-coat | 3/1 | 1/7 |
| | sheet/clear sheet | | |
| | total light transmittance(%) | 93 | 90.3 |
| | haze(%) | 0.3 | 0.9 |
| polyurethane | viscosity (mPa · s) | 5000 | 5000 |
| adhesive of | Young's modulus (Mpa) | 1 | 1 |
| protective layer- | film thickness(μ) | 100 | 100 |
| side adhesive layer | | | |
| filling layer(coating urethane-sealer) | | presence | presence |
| decor sheet | kind of material | Birds Eye | Birds Eye |
| (sliced veneer) | channel depth(μ) | 60 | 60 |
| (thickness/channel depth of adhesive | | 2/1 | 2/1 |
| layer at the protective layer side) | | | |
| base material | quality of material | polyester | polyester |
| bonding layer | | nonwoven fabrics | nonwoven fabrics |
| base material | quality of material | PC/ABS | PC/ABS |

| | | | |
|---|---|---|---|
| molding | vacuum molding temperature | 85 | 100 |
| conditions | (sheet surface temperature ° C.) | | |
| | hot-press molding (mold temperature ° C.) | — | — |

TABLE 9

| Sample No. | | | Sample E12 | Sample E13 | Sample E14 | Sample E15 | Sample E16 |
|---|---|---|---|---|---|---|---|
| quality | appearance | unevenness on the design surface | none | none | none | none | none |
| | characteristics | hardness of the outermost surface | 2H | 2H | 2H | 2H | 2H |
| | | floating and peeling | none | none | none | none | none |
| | | radius of curvature(mm) | 2.0 | 2.0 | 2.0 | 2.0 | 2.0 |
| | bubbles | presence of bubbles | none | none | none | none | none |
| | adhesion | 80° C. adhesive strength(N/25 mm) | 29.4N | 29.4N | 28.5N | 32.3N | 29.4N |
| | properties | | breaking of | breaking of | breaking of | breaking of | breaking of |
| | | | sliced veneer | sliced veneer | sliced veneer | sliced veneer | sliced veneer |
| | heat | test temperature | 100 | 100 | 100 | 100 | 100 |
| | resistance | presence of unevenness | none | none | none | none | none |
| | | floating and peeling of curved portion | none | none | none | none | none |

TABLE 10

| Sample No. | | | Sample E17 | Sample E18 | Sample E19 | Sample E20 | Sample E21 | Sample E22 |
|---|---|---|---|---|---|---|---|---|
| quality | appearance | unevenness on the design surface | none | none | none | none | none | none |
| | characteristics | hardness of the outermost surface | 3H | 2H | 2H | 2H | 2H | 2H |
| | | floating and peeling | none | none | none | none | none | none |
| | | radius of curvature(mm) | 2.0 | 2.0 | 2.0 | 2.0 | 2.0 | 2.0 |
| | bubbles | presence of bubbles | none | none | none | none | none | none |
| | adhesion | 80° C. adhesive strength(N/25 mm) | 29.4N | 29.4N | 31.0N | 29.4N | 29.4N | 29.4N |
| | properties | | breaking of | breaking of | breaking of | breaking of | breaking of | breaking of |
| | | | sliced veneer | sliced veneer | sliced veneer | sliced veneer | sliced veneer | sliced veneer |
| | heat | test temperature | 100 | 100 | 100 | 100 | 100 | 100 |
| | resistance | presence of unevenness | none | none | none | none | none | none |
| | | floating and peeling of curved portion | none | none | none | none | none | none |

TABLE 11

| Sample No. | | | Sample C7 | Sample C8 | Sample C9 | Sample C10 |
|---|---|---|---|---|---|---|
| quality | appearance | unevenness on the design surface | presence | presence | none | none |
| | characteristics | hardness of the outermost surface | 2H | 2H | 2H | 2H |
| | | floating and peeling | presence | none | none | none |
| | | radius of curvature(mm) | 10 | 2.0 | 2.0 | 2.0 |
| | bubbles | presence of bubbles | presence | none | presence | presence |
| | adhesion | 80° C. adhesive strength(N/25 mm) | 29.8N | 30.5N | 15.3N | 38.5N |
| | properties | | breaking of | breaking of | peeling of | breaking of |
| | | | sliced veneer | sliced veneer | interface | sliced veneer |
| | heat | test temperature | 100 | 100 | 100 | 100 |
| | resistance | presence of unevenness | none | presence | none | none |
| | | floating and peeling of curved portion | none | none | none | presence |

TABLE 12

| Sample No. | | | Sample C11 | Sample C12 |
|---|---|---|---|---|
| quality | appearance | unevenness on the design surface | presence | presence |
| | characteristics | hardness of the outermost surface | 2H | HB |
| | | floating and peeling | none | none |
| | | radius of curvature(mm) | 2.0 | 2.0 |
| | bubbles | presence of bubbles | none | none |
| | adhesion | 80° C. adhesive strength(N/25 mm) | 29.4N | 29.4N |
| | properties | | breaking of | breaking of |
| | | | sliced veneer | sliced veneer |
| | heat | test temperature | 100 | 100 |
| | resistance | presence of unevenness | presence | none |
| | | floating and peeling of curved portion | none | none |

As is apparent from Tables 5 to 12, the samples E12 to E22 according to Examples of the present invention were excellent in appearance characteristics and exhibited excellent design property even when a curved portion having a small radius of curvature of 2.0 mm was formed. Further, they were also excellent in adhesive property and heat resistance.

However, although occurrence of bubbles was suppressed and appearance characteristics were excellent in the sample E22 in which the thickness ratio (T1/T2) of the hard-coat sheet and the clear sheet was significantly reduced, the surface hardness was insufficient and the scuff resistance was deteriorated.

On the other hand, the samples C7 to C12 had a problem of appearance characteristics.

Further, in the samples E12 to E22, the protective layer-side adhesive layer was formed so as to have a thickness more than twice the maximum value of the depth of the groove portion on the surface of the porous decor sheet (refer to Tables 5 and 6). Thus, occurrence of bubbles is sufficiently suppressed (refer to Tables 9 and 10).

On the other hand, in the samples C9 and 010, the thickness of the protective layer-side adhesive layer is not sufficient based on the depth of the groove portion (refer to Table 7). For that reason, in the samples C9 and C10, it is considered that bubbles are further easily generated (refer to Table 11).

In this regard, description will be made with reference to drawings.

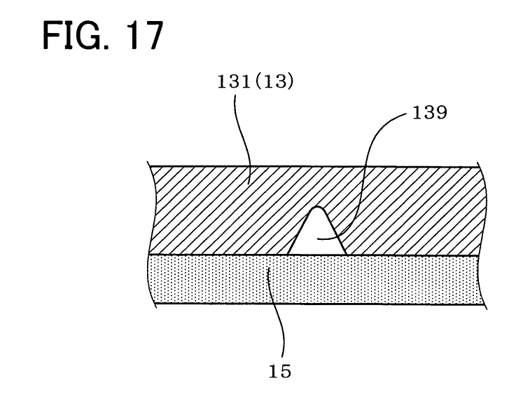

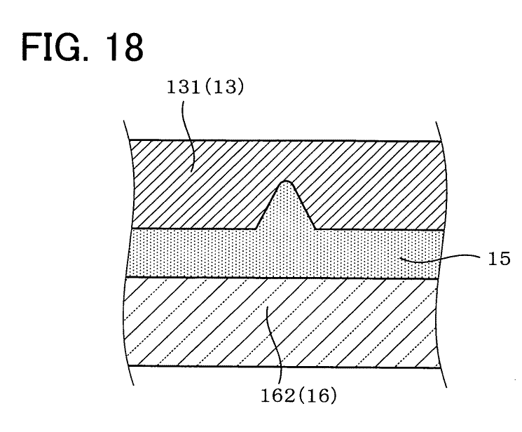

When the protective layer-side adhesive layer 15 is formed at the side of the sliced veneer 131 of the decor sheet 13, and is bonded to the surface protective layer 16 at the side of the clear sheet 162 using the laminating apparatus in the same manner as described in Example 1, in the case where the surface protective layer 16 is formed so as to have a sufficient thickness such as more than twice the depth of the groove portion 139 of the sliced veneer 131 as with the samples E12 to E22, the protective layer-side adhesive layer 15 is formed in the groove portion 139, and thus occurrence of bubbles is suppressed (refer to FIGS. 17 and 18).

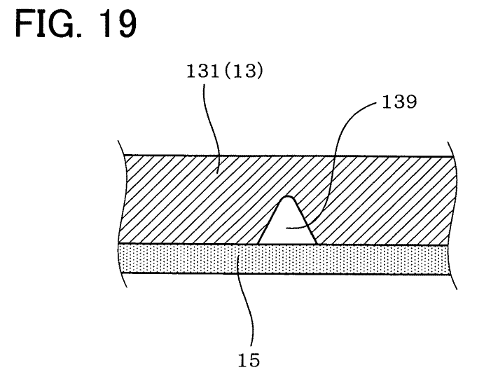

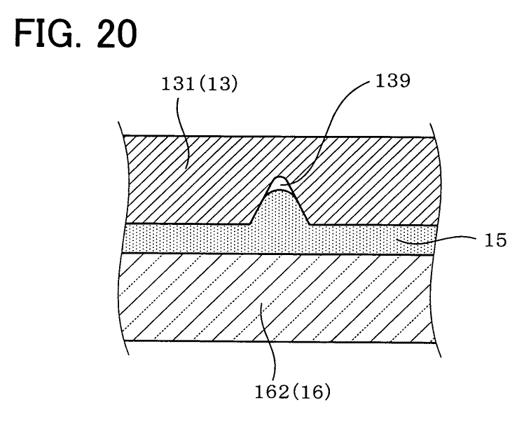

On the other hand, when the surface protective layer 16 is formed so as to have a thickness less than twice the depth of the groove portion 139 of the sliced veneer 131 as with the samples C9 and C10, the protective layer-side adhesive layer 15 is not formed in the groove portion 139. Therefore, it is considered that bubbles may be occurred (refer to FIGS. 19 and 20).

In this regard, although the filling layer is provided between the sliced veneer 131 and the protective layer-side adhesive layer 15, the thickness of the filling layer is sufficiently small as compared to those of the sliced veneer 131 and the protective layer-side adhesive layer 15 and the like. Thus, the filling layer is not shown in FIGS. 17 to 20.

As described above, according to the present example, there can be provided the decorative sheet which enables to suppress occurrence of bubbles from the porous decor sheet and unevenness on the surface, and to provide the decorative molded article with excellent design property, even if the decorative sheet is applied to the decorative molded article requiring deep drawing, and the decorative molded articles (the samples E12 to E22).

Obviously, numerous modifications and variations of the present invention are possible in light of the above teachings. It is therefore to be understood that, within the scope of the appended claims, the invention may be practiced otherwise than as specifically described here.

1. A decorative sheet used by forming a curved portion by vacuum molding or hot-press molding, and injection-molding a base material resin to the rear surface side in a mold thereby to be integrated with the base material resin,
wherein the decorative sheet is formed by integrally laminating a base material-side adhesion layer, a porous decor sheet, a protective layer-side adhesive layer, and a transparent surface protective layer from the rear surface side in this order,
the protective layer-side adhesive layer is formed by curing a moisture curing type of transparent polyurethane adhesive,
the surface protective layer contains polymethylmethacrylate, a composite resin of polycarbonate and polybutylene terephthalate or a composite resin of polycarbonate and polyethylene terephthalate as a main component, and has a glass transition point of 90 to 130° C., and
the thickness of the surface protective layer is 300 μm or more.

2. The decorative sheet according to claim 1, wherein the protective layer-side adhesive layer is formed so as to have a thickness not less than twice the maximum value of the depth of a groove portion on the surface of the porous decor sheet.

3. The decorative sheet according to claim 1, wherein the base material-side adhesion layer has a base material bonding layer that bonds with the base material resin, and a base material-side adhesive layer that attaches between the base material bonding layer and the decor sheet.

4. The decorative sheet according to claim 3, wherein the base material bonding layer is formed of a nonwoven fabric.

5. The decorative sheet according to claim 3, wherein the base material-side adhesive layer is formed by curing a moisture curing type of transparent polyurethane adhesive.

6. The decorative sheet according to claim 1, wherein a filling layer is formed between the protective layer-side adhesive layer and the decor sheet.

7. The decorative sheet according to claim 6, wherein the filling layer is formed by applying a sealing material that contains a polyurethane resin or an acrylic resin as a main component onto the decor sheet and curing the sealing material.

8. The decorative sheet according to claim 1, wherein the decor sheet is formed by attaching a sliced veneer and a nonwoven fabric formed at the rear surface side of the sliced veneer by use of an adhesive.

9. The decorative sheet according to claim 1, wherein the surface protective layer includes a transparent clear sheet that contains a composite resin of polycarbonate and polybutylene terephthalate or a composite resin of polycarbonate and polyethylene terephthalate as a main component and a transparent hard-coat sheet that contains polymethylmethacrylate as a main component in this order from the rear surface side.

10. The decorative sheet according to claim 9, wherein, assuming that the thickness of hard-coat sheet is T1 and the thickness of the clear sheet is T2, T1/T2 is 1/7 to 1.

11. The decorative sheet according to claim 9, wherein a compounding ratio of polycarbonate (PC) and polybutylene terephthalate (PBT) or polyethylene terephthalate (PET) in the clear sheet is PC:PBT (or PET)=52−85:48−15 based on a weight ratio.

12. The decorative sheet according to claim 9, wherein the hard-coat sheet contains an acrylic rubber as an accessory component.

13. The decorative sheet according to claim 9, wherein the surface protective layer is formed by attaching a laminate sheet obtained by co-extruding the hard-coat sheet and the clear sheet to the protective layer-side adhesive layer.

14. The decorative sheet according to claim 1, wherein the surface protective layer is formed of a transparent hard-coat sheet that contains polymethylmethacrylate as a main component.

15. The decorative sheet according to claim 14, wherein the hard-coat sheet contains an acrylic rubber as an accessory component.

16. The decorative sheet according to claim 1, wherein the surface protective layer is formed of a transparent clear sheet that contains a composite resin of polycarbonate and polybutylene terephthalate or a composite resin of polycarbonate and polyethylene terephthalate as a main component.

17. The decorative sheet according to claim 16, wherein a compounding ratio of polycarbonate (PC) and polybutylene terephthalate (PBT) or polyethylene terephthalate (PET) in the clear sheet is PC:PBT (or PET)=52 to 85:48 to 15 based on a weight ratio.

18. A decorative molded article obtained by forming a curved portion on a decorative sheet by vacuum molding or press molding, placing the decorative sheet in a mold, and injection-molding a base material resin to a rear surface side of the decorative sheet in the mold, wherein the decorative sheet according to claim 1 is employed as the decorative sheet.

19. The decorative molded article according to claim 18, wherein a coating material that contains a thermosetting or ultraviolet-curable acrylic resin or a thermosetting or ultraviolet-curable urethane resin as a main component are applied onto the surface protective layer formed of a clear sheet that contains the composite resin of polycarbonate and polybutylene terephthalate or the composite resin of polycarbonate and polyethylene terephthalate as a main component in the decorative molded article obtained after injection-molding and cured.

20. The decorative molded article according to claim 18, wherein the decorative molded article is formed by integrally injection-molding the base material resin to the rear surface side of the decorative sheet, injection-molding a coating material that contains a thermosetting or ultraviolet curing acrylic resin or a thermosetting or ultraviolet-curing urethane resin as a main component on the surface protective layer formed of the clear sheet that contains the composite resin of polycarbonate and polybutylene terephthalate or the composite resin of polycarbonate and polyethylene terephthalate as a main component at the surface side of the decorative sheet.
